(19) United States
(12) Patent Application Publication
(10) Pub. No.: US 2025/0232477 A1
(43) Pub. Date: Jul. 17, 2025

(54) 3D DATA DECODING APPARATUS AND 3D DATA CODING APPARATUS

(71) Applicant: SHARP KABUSHIKI KAISHA, Sakai City (JP)

(72) Inventors: Sujun HONG, Sakai City (JP); YASUAKI TOKUMO, Sakai City (JP); Keiichiro TAKADA, Sakai City (JP); TOMOHIRO IKAI, Sakai City (JP); TAKESHI CHUJOH, Sakai City (JP)

(21) Appl. No.: 19/012,034

(22) Filed: Jan. 7, 2025

(30) Foreign Application Priority Data
Jan. 16, 2024 (JP) 2024-004374

(51) Int. Cl. G06T 9/00; H04N 19/70

(52) U.S. Cl. CPC G06T 9/001; H04N 19/70

(57) ABSTRACT

A 3D data decoding apparatus for decoding mesh data or point cloud data includes a submesh decoder configured to decode submesh information from coded data in which the mesh data or the point cloud data is coded, a base mesh decoder configured to decode a base mesh from the coded data and the submesh information, a mesh displacement decoder configured to decode a mesh displacement from the coded data and the submesh information, and a mesh reconstructor configured to decode a mesh from the base mesh and the mesh displacement being decoded. The mesh displacement decoder decodes the mesh displacement from the coded data using the submesh information decoded in the submesh decoder.

### CROSS-REFERENCE TO RELATED APPLICATIONS

This application claims the benefit of priority to Japanese Patent Application Number 2024-004374 filed on Jan. 16, 2024. The entire contents of the above-identified application are hereby incorporated by reference.

### TECHNICAL FIELD

Embodiments of the present disclosure relate to a 3D data coding apparatus and a 3D data decoding apparatus.

### BACKGROUND ART

A 3D data coding apparatus that converts 3D data into a two-dimensional image and codes it using a video coding scheme to generate coded data and a 3D data decoding apparatus that decodes a two-dimensional image from the coded data to reconstruct 3D data are provided to efficiently transmit or record 3D data.

Specific 3D data coding schemes include, for example, MPEG-I ISO/IEC 23090-5 Visual Volumetric Video-based Coding (V3C) and Video-based Point Cloud Compression (V-PCC). V3C can encode and decode a point cloud including point positions and attribute information. V3C is also used to encode and decode multi-view videos and mesh videos through ISO/IEC 23090-12 (MPEG Immersive Video (MIV)) and ISO/IEC 23090-29 (Video-based Dynamic Mesh Coding (V-DMC)) that is currently being standardized. A latest draft document of the V-DMC scheme is disclosed in NPL 1.

In such 3D data coding schemes, geometries and attributes that constitute 3D data are coded and decoded as images using a video coding scheme such as H.265/HEVC (High Efficiency Video Coding) or H.266/VVC (Versatile Video Coding).

In the case of a point cloud, a geometry image is an image corresponding to depths to the projection plane and an attribute image is an image of attributes projected onto the projection plane.

The 3D data (mesh) as described in NPL 1 includes a base mesh, a mesh displacement, and a texture-mapped image. A vertex coding scheme such as Draco can be used for coding the base mesh. Methods for coding the mesh displacement include direct coding by arithmetic coding, in addition to a method of using video codec to code a mesh displacement image obtained by two-dimensionally converting the mesh displacement. The texture-mapped image is coded as an attribute image by a video codec. As a video codec, the above-described HEVC and VVC can be used.

### CITATION LIST

### Non Patent Literature

NPL 1:
WD 5.0 of V-DMC (MDS23318_WG07_N00744_clean), ISO/IEC JTC 1/SC 29/WG 7 N0744, October 2023

### Summary of Disclosure

### Technical Problem

The 3D data coding scheme disclosed in NPL 1 allows coding and decoding of mesh displacements (mesh displacement array, mesh displacement image) constituting 3D data (mesh) using an arithmetic coding method. There is a problem in that the mesh displacement is arithmetically coded to be coded and decoded in a unit of a frame but cannot be coded and decoded in a unit smaller than a frame (in a unit of a submesh).

The present disclosure has an object to enhance granularity of coding of a mesh displacement and encode and decode 3D data with high efficiency in coding and decoding of the 3D data using an arithmetic coding method.

### Solution to Problem

In order to solve the problem described above, a 3D data decoding apparatus according to an aspect of the present disclosure is a 3D data decoding apparatus for decoding mesh data or point cloud data, including a submesh decoder configured to decode submesh information from coded data in which the mesh data or the point cloud data is coded, a base mesh decoder configured to decode a base mesh from the coded data and the submesh information, a mesh displacement decoder configured to decode a mesh displacement from the coded data and the submesh information, and a mesh reconstructor configured to decode a mesh from the base mesh and the mesh displacement being decoded. The mesh displacement decoder decodes the mesh displacement from the coded data, using the submesh information decoded in the submesh decoder.

In order to solve the problem described above, a 3D data coding apparatus according to an aspect of the present disclosure is a 3D data coding apparatus for coding mesh data or point cloud data, including a submesh encoder configured to code submesh information, a base mesh encoder configured to code a base mesh, using the submesh information, and a mesh displacement encoder configured to code a mesh displacement, using the submesh information.

The mesh displacement encoder codes the mesh displacement, using the submesh information coded in the submesh encoder.

### Advantageous Effects of Disclosure

According to an aspect of the present disclosure, coding efficiency for a mesh displacement can be enhanced, and 3D data can be coded and decoded with high quality.

### BRIEF DESCRIPTION OF DRAWINGS

FIG. 1 is a schematic diagram illustrating a configuration of a 3D data transmission system according to the present embodiment.

FIG. 2 is a diagram illustrating a hierarchical structure of data of a coding stream.

FIG. 3 is a functional block diagram illustrating a schematic configuration of a 3D data decoding apparatus 31.

FIG. 4 is a functional block diagram illustrating a configuration of a base mesh decoder 303.

FIG. 5 is a functional block diagram illustrating a configuration of a mesh displacement decoder 305.

FIG. 6 is a functional block diagram illustrating a configuration of a mesh reconstructor 307.

FIG. 7 is an example of syntax of a configuration for transmitting coordinate conversion parameters and context initialization parameters at a sequence level (ASPS).

FIG. 8 is an example of syntax of a configuration for transmitting coordinate conversion parameters and context initialization parameters at a picture/frame level (AFPS).

FIG. 9 is a diagram for illustrating operation of the mesh reconstructor 307.

FIG. 10 is a functional block diagram illustrating a schematic configuration of a 3D data coding apparatus 11.

FIG. 11 is a functional block diagram illustrating a configuration of a base mesh encoder 103.

FIG. 12 is a functional block diagram illustrating a configuration of a mesh displacement encoder 107.

FIG. 13 is a functional block diagram illustrating a configuration of a mesh separator 115.

FIG. 14 is a diagram for illustrating operation of the mesh separator 115.

FIG. 15 is an example of syntax of a configuration for transmitting coordinate conversion parameters and context initialization parameters of a mesh displacement at a sequence level (DSPS).

FIG. 16 is an example of syntax of a configuration for transmitting coordinate conversion parameters and context initialization parameters of a mesh displacement at a picture/frame level (DFPS).

FIG. 17 is an example of syntax of submesh information of a mesh displacement.

FIG. 18 is an example of syntax for transmitting a data unit of a mesh displacement.

FIG. 19 is an example of syntax for transmitting a data unit of a mesh displacement.

FIG. 20 is an example of a NAL unit type of a mesh displacement.

FIG. 21 is an example of syntax of a configuration for transmitting mesh/submesh information at a picture/frame level (AFPS).

FIG. 22 is an example of syntax of a configuration for transmitting mesh/submesh information at a picture/frame level (AFPS).

FIG. 23 is an example of syntax of a configuration for transmitting mesh/submesh information at a picture/frame level (AFPS).

FIG. 24 is an example of syntax of a configuration for transmitting mesh/submesh information at a picture/frame level (AFPS).

FIG. 25 is an example of syntax of a configuration for transmitting mesh/submesh information at a picture/frame level (AFPS).

### DESCRIPTION OF EMBODIMENTS

Embodiments of the present disclosure will be described below with reference to the drawings.

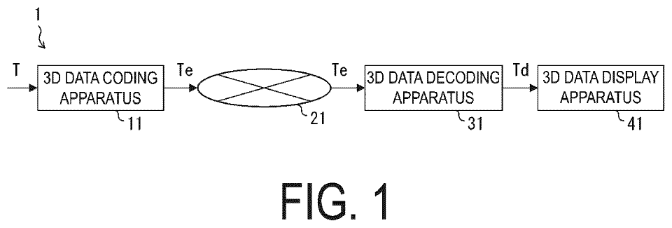

FIG. 1 is a schematic diagram illustrating a configuration of a 3D data transmission system 1 according to the present embodiment.

The 3D data transmission system 1 is a system that transmits a coding stream obtained by coding 3D data to be encoded, decodes the transmitted coding stream, and displays 3D data. The 3D data transmission system 1 includes a 3D data coding apparatus 11, a network 21, a 3D data decoding apparatus 31, and a 3D data display apparatus 41.

3D data T is input to the 3D data coding apparatus 11.

The network 21 transmits a coding stream Te generated by the 3D data coding apparatus 11 to the 3D data decoding apparatus 31. The network 21 is the Internet, a Wide Area Network (WAN), a Local Area Network (LAN), or a combination thereof. The network 21 is not limited to a bidirectional communication network and may be a unidirectional communication network that transmits broadcast waves for terrestrial digital broadcasting, satellite broadcasting, or the like. The network 21 may be replaced by a storage medium on which the coding stream Te is recorded, such as a Digital Versatile Disc (DVD) (trade name) or a Blu-ray Disc (BD) (trade name).

The 3D data decoding apparatus 31 decodes each coding stream Te transmitted by the network 21 and generates one or more pieces of decoded 3D data Td.

The 3D data display apparatus 41 displays all or some of one or more pieces of decoded 3D data Td generated by the 3D data decoding apparatus 31. The 3D data display apparatus 41 includes a display apparatus such as, for example, a liquid crystal display or an organic Electro-luminescence (EL) display. Examples of display types include stationary, mobile, and HMID.

The 3D data display apparatus 41 displays a high quality image in a case that the 3D data decoding apparatus 31 has high processing capability and displays an image that does not require high processing or display capability in a case that it has only lower processing capability.

Operators Operators used in the present specification will be described below.

“»” is a right bit shift, “«” is a left bit shift, “&” is a bitwise AND, is a bitwise OR, “|=” is an OR assignment operator, and “∥” indicates a logical sum.

x ?y: z is a ternary operator that takes y in a case that x is true (other than 0) and takes z in a case that x is false (0).

“y.. z” indicates a set of integers from y to z.

### Structure of Coding Stream Te

Prior to a detailed description of a 3D data coding apparatus 11 and a 3D data decoding apparatus 31 according to the present embodiment, a data structure of the coding stream Te generated by the 3D data coding apparatus 11 and decoded by the 3D data decoding apparatus 31 will be described.

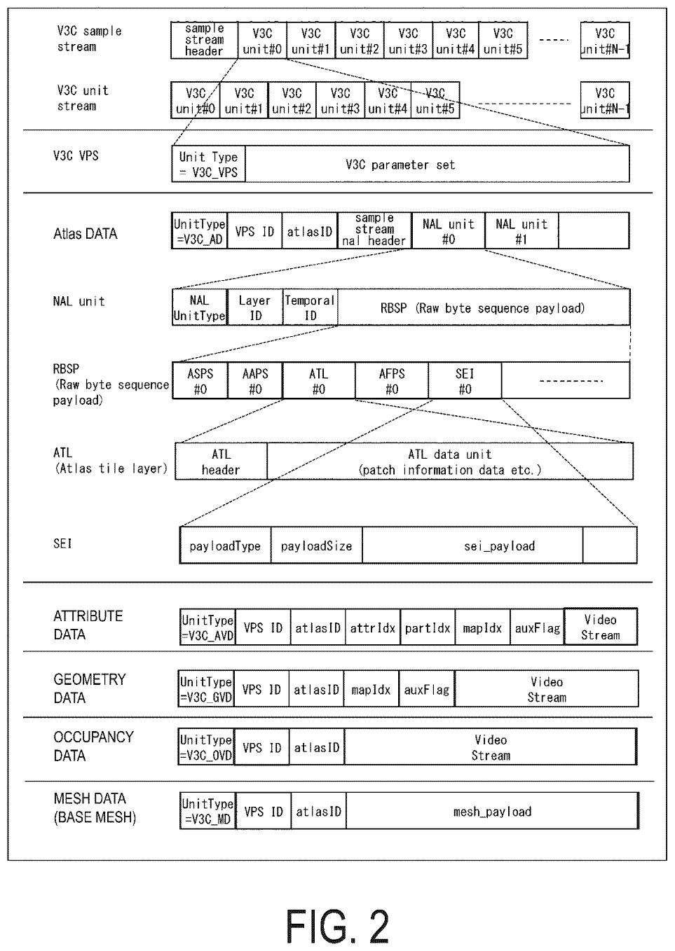

FIG. 2 is a diagram illustrating a hierarchical structure of data of the coding stream Te. The coding stream Te has a data structure of either a V3C sample stream or a V3C unit stream. A V3C sample stream includes a sample stream header and V3C units. The V3C unit stream includes a V3C unit.

Each V3C unit includes a V3C unit header and a V3C unit payload. The V3C unit header is a Unit Type that is an ID indicating the type of the V3C unit, and takes a value indicated by a label such as V3C_VPS, V3C_AD, V3C_AVD, V3C_GVD, or V3C_OVD.

In a case that the Unit Type is a V3C_VPS (Video Parameter Set), the V3C unit includes a V3C parameter set.

In a case that the Unit Type is V3C_AD (Atlas Data), the V3C unit includes a VPS ID, an atlasID, a sample stream nal header, and multiple NAL units. The atlasID is Identification (ID) and takes an integer value of 0 or more.

Each NAL unit includes a NALUnitType, a layerID, a TemporalID, and a Raw Byte Sequence Payload (RBSP).

A NAL unit is identified by NALUnitType and includes an Atlas Sequence Parameter Set (ASPS), an Atlas Adaptation Parameter Set (AAPS), an Atlas Tile Layer (ATL), Supplemental Enhancement Information (SEI), and the like.

The ATL includes an ATL header and an ATL data unit and the ATL data unit includes information on positions and sizes of patches or the like such as patch information data.

The SEI includes a payloadType indicating the type of the SEI, a payloadSize indicating the size (number of bytes) of the SEI, and an sei_payload which is data of the SEI.

In a case that the Unit Type is V3C_AVD (Attribute Video Data, attribute data), the V3C unit includes a VPS ID, an atlasID, an attrIdx which is an attribute image ID, a partIdx which is a partition ID, a mapIdx which is a map ID, a flag auxFlag indicating whether the data is Auxiliary data, and a video stream. The video stream is data coded by HEVC, VVC, or the like. The attribute data corresponds to a texture image in the V-DMC.

In a case that the NalUnitType is V3C_GVD (Geometry Video Data, geometry data), the V3C unit includes a VPS ID, an atlasID, a mapIdx, an auxFlag, and a video stream. The geometry data corresponds to mesh displacements in the V-DMC.

In a case that the Unit Type is V3C_OVD (Occupancy Video Data, occupancy data), the V3C unit includes the VPS ID, atlasID, and the video stream.

In a case that the Unit Type is V3C_MD (Mesh Data), the V3C unit includes a VPS ID, an atlasID, and a mesh_payload. In V-DMC, this corresponds to a base mesh.

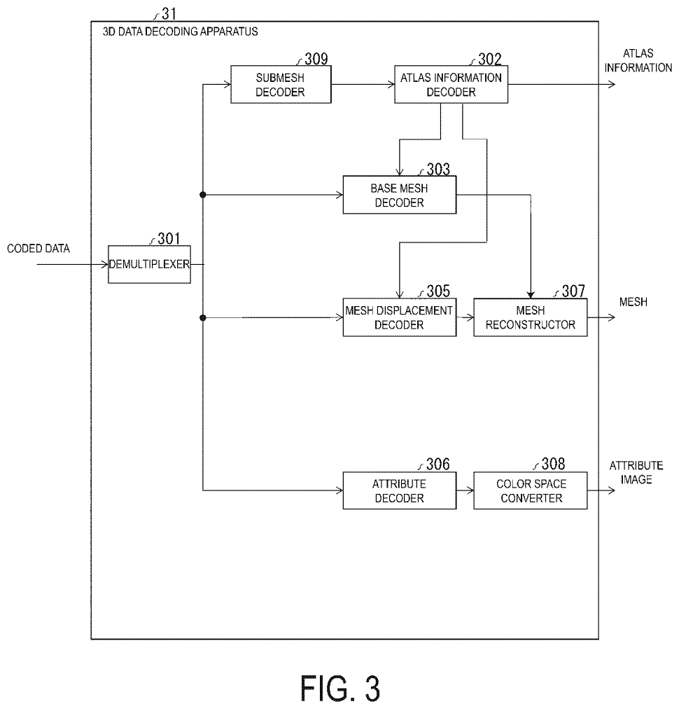

Configuration of 3D Data Decoding Apparatus According to First Embodiment FIG. 3 is a functional block diagram illustrating a schematic configuration of the 3D data decoding apparatus 31 according to a first embodiment. The 3D data decoding apparatus 31 includes a demultiplexer 301, a submesh decoder 309, an atlas information decoder 302, a base mesh decoder 303, a mesh displacement decoder 305, a mesh reconstructor 307, an attribute decoder 306, and a color space converter 308. The 3D data decoding apparatus 31 receives coded data of 3D data and outputs atlas information, mesh, and an attribute image.

The demultiplexer 301 receives coded data multiplexed in a byte stream format, an ISOBMFF (ISO Base Media File Format), or the like and demultiplexes it and outputs a coded atlas information stream (an Atlas Data stream of V3C_AD and NALunits), a coded base mesh stream (a mesh_payload of V3C_MD), a coded mesh displacement stream (a video stream of V3C_GVD), and an attribute video stream (a video stream of V3C_AVD).

The submesh decoder 309 receives the coded atlas information submesh stream output from the demultiplexer 301 and decodes submesh information.

The atlas information decoder 302 receives the coded atlas information stream output from the submesh decoder 309 and decodes atlas information.

The atlas information decoder 302 in FIG. 3 decodes coded data to obtain coordinate system conversion information displacementCoordinateSystem (asps_vdmc_ext displacement_coordinate_system, afps_vdmc_ext displacement_coordinate_system) indicating a coordinate system. Note that a gating flag may also be provided separately and each piece of coordinate system conversion information may be decoded only in a case that the gating flag is 1. The gating flag is afve_displacement_coordinate_system_enable_flag, for example.

The base mesh decoder 303 decodes a coded base mesh stream that has been coded by vertex coding (a 3D data compression coding scheme such as, for example, Draco) and outputs a base mesh. The base mesh will be described later.

The mesh displacement decoder 305 decodes a coded mesh displacement stream and outputs mesh displacements.

The mesh reconstructor 307 receives the base mesh and mesh displacements and reconstructs a mesh in 3D space.

The attribute decoder 306 decodes an attribute video stream obtained by coding such as VVC or HEVC, and outputs an attribute image. The attribute image may be a texture image (a texture mapped image obtained by transform by a UV atlas method) expanded on a UV axis and may be in a YCbCr format. The type of codec used for coding is indicated by a ptl_profile_codec_group_idc obtained by decoding the V3C parameter set of coded data. This may also be indicated by a Four CC code indicated by an ai_geometry_codec_id[atlasID] in the V3C parameter set. The ai_geometry_codec_id[atlasID] indicates an index corresponding to the codec ID of a decoder used to decode the attribute video stream in the atlas ID.

The color space converter 308 performs color space conversion of the attribute image from a YCbCr format to an RGB format. Note that it is also possible to adopt a configuration in which an attribute video stream coded in an RGB format is decoded and color space conversion is omitted.

### Decoding of Base Mesh

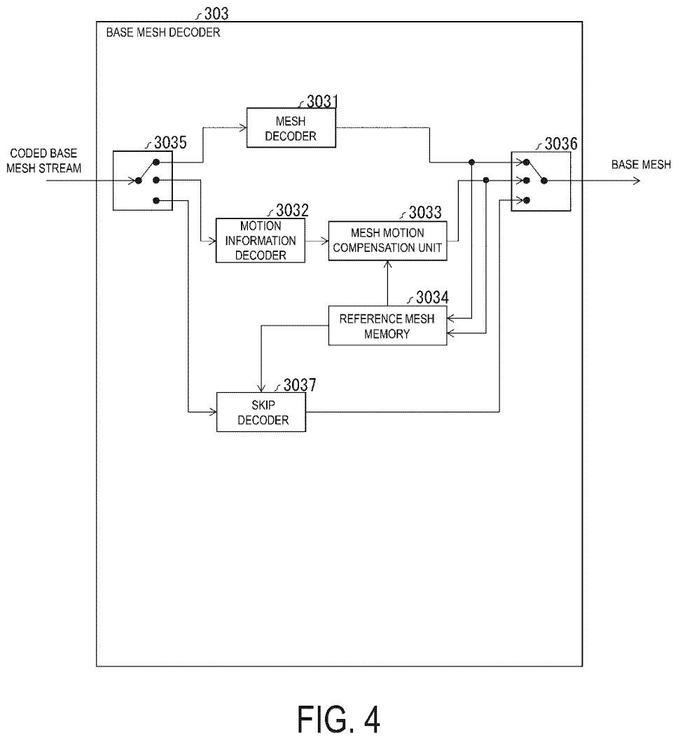

FIG. 4 is a functional block diagram illustrating a configuration of the base mesh decoder 303. The base mesh decoder 303 includes a mesh decoder 3031, a motion information decoder 3032, a mesh motion compensation unit 3033, a reference mesh memory 3034, a switch 3035, a switch 3036, and a skip decoder 3037. The base mesh decoder 303 may include a base mesh inverse quantization unit (not illustrated) prior to output of the base mesh. In a case that the target base mesh to be decoded is coded (intra-coded) without referring to another base mesh (for example, an already coded and decoded base mesh), the switch 3035 and the switch 3036 are connected on the mesh decoder 3031 side. In contrast, in a case that the target base mesh to be decoded is coded (inter-coded) by referring to another base mesh, they are connected on the side to perform motion compensation. In a case that motion compensation is performed, the target vertex coordinates are derived by referring to already decoded vertex coordinates and motion information. In contrast, in a case that the target base mesh to be decoded is skipped and another base mesh is coded (skip-coded) as the target to be decoded, they are connected on the skip decoder 3037 side.

Each base mesh includes one or multiple submeshes. In a case that multiple submeshes are present, the tile header in an atlas data sub-bitstream requires an ID to search for a submesh corresponding to the tile. Here, the submesh is a subset of meshes defined by indicating a part of a three-dimensional model, and is a mesh obtained by dividing a mesh into multiple parts. By dividing meshes into a subset to finely control a part of the three-dimensional model, meshes in a specific range can be individually defined. Each submesh includes unique vertex coordinates, normal vectors, texture coordinates, and the like, and can be individually operated and edited. A mesh of a certain frame is referred to as a mesh frame.

The mesh decoder 3031 decodes a coded base mesh stream that has been intra-coded and outputs a base mesh (a base mesh vertex position, a base mesh vertex position vector). Draco, edge breaker, or the like is used as a coding scheme.

The motion information decoder 3032 decodes a coded base mesh stream that has been inter-coded and outputs motion information (mesh motion information, a mesh motion vector) for each vertex of a reference mesh which will be described later. Entropy coding such as arithmetic coding is used as a coding scheme.

The mesh motion compensation unit 3033 performs motion compensation on each vertex of the reference mesh received from the reference mesh memory 3034 based on the motion information and outputs a motion-compensated mesh.

The reference mesh memory 3034 is a memory that holds decoded meshes for reference in subsequent decoding processing.

### Decoding of Mesh Displacements

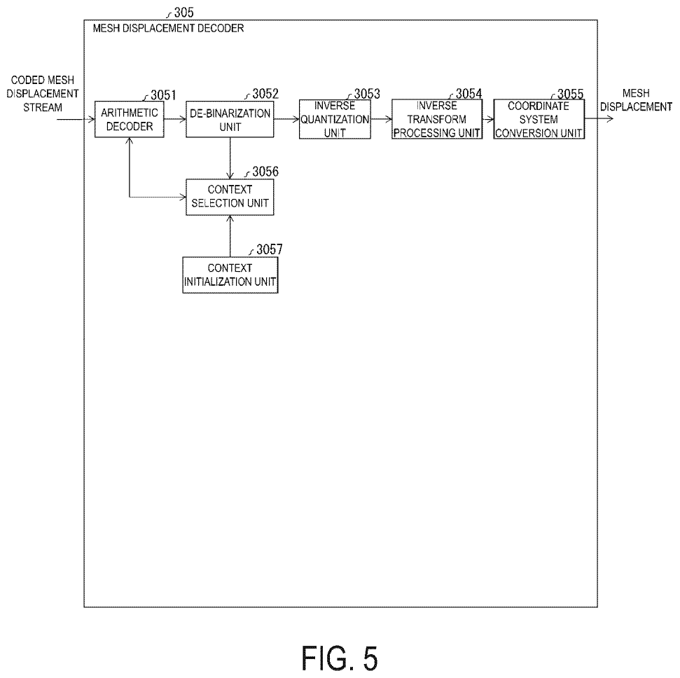

FIG. 5 is a functional block diagram illustrating a configuration of the mesh displacement decoder 305. The mesh displacement decoder 305 includes a CABAC decoder (an arithmetic decoder 3051, a de-binarization unit 3052, a context selection unit 3056, and a context initialization unit 3057), an inverse quantization unit 3053, an inverse transform processing unit 3054, and a coordinate system conversion unit 3055.

### Context-adaptive Binary Arithmetic Coding

The arithmetic decoder 3051, the de-binarization unit 3052, the context selection unit 3056, and the context initialization unit 3057 use a decoding method using context, which is referred to as Context-Adaptive Binary Arithmetic Coding (CABAC). In CABAC, a binary string including 0s and is 1s encoded and decoded for each bit using a state variable (CABAC state) referred to as a context. All CABAC states are initialized at the beginning of a segment. The CABAC decoder decodes each bit of a binary string (Bin String) corresponding to a syntax element. In a case that a context is used, a context index ctxIdx is derived for each bit of the syntax element, the bit is decoded using the context, and the CABAC state of the context is updated. Bits for which no context is used are decoded with equal probability (EP, bypass), and update of the index ctxIdx, indicating a context, and the specified context is omitted. The context is a variable (memory area) for holding the probability (state) of CABAC, and is identified by the value (0, 1, 2, . . . ) of ctxIdx. A case that 0 and 1 are always equal in probability, i.e., 0 and 1 both have a probability of 0.5, is called Equal Probability (EP) or bypass. In this case, no context is used because no state needs to be held for a particular syntax element. A static context may be used in which the probability is fixed at 0.5 and need not need be updated. In this sense, the context may be referred to as static rather than bypass. An integer value such as 128 may be used as a value indicating the probability of 0.5.

Note that the following pseudocode may be used for the processing of decoding one bit (by bypassing) without using a context.

```
rangeTimesProb = IvlRange >> 1
binVal = ( rangeTimesProb <= ( IvlCode − IvlLow ) )
if (binVal == 0)
  IvlRange = rangeTimesProb
else {
  IvlLow += rangeTimesProb
  IvlRange −= rangeTimesProb
}
```

Note that the following pseudocode may be used for the processing of decoding one bit using a context. Here, prob0 is a variable indicating the probability of the context.

```
rangeTimesProb = IvlRange * prob0 >> 16
binVal = ( rangeTimesProb <= ( IvlCode − IvlLow ) )
if (binVal == 0)
  IvlRange = rangeTimesProb
else {
  IvlLow += rangeTimesProb
  IvlRange −= rangeTimesProb
}
```

### Coordinate Systems

The following two types of coordinate systems are used as coordinate systems for mesh displacements (three-dimensional vectors).

Cartesian coordinate system (canonical): An orthogonal coordinate system that is commonly defined throughout 3D space. An (X, Y, Z) coordinate system. An orthogonal coordinate system whose directions do not change at the same time (within the same frame or within the same tile).

Local coordinate system (local): An orthogonal coordinate system defined for each region or each vertex in 3D space. An orthogonal coordinate system whose directions can change at the same time (within the same frame or within the same tile). A coordinate system with a normal axis (D), a tangent axis (U), and a bi-tangent axis (V). That is, the local coordinate system is an orthogonal coordinate system that has a first axis (D) indicated by a normal vector n_vec at a certain vertex (on a surface including a certain vertex) and a second axis (U) and a third axis (V) indicated by two tangent vectors t_vec and b_vec orthogonal to the normal vector n_vec. n_vec, t_vec, and b_vec are three-dimensional vectors. The (D, U, V) coordinate system may also be referred to as an (n, t, b) coordinate system.

### Decoding and Derivation of Sequence-Level Control Parameters

Here, sequence-level control parameters to be decoded from coded data in the mesh displacement decoder 305 will be described.

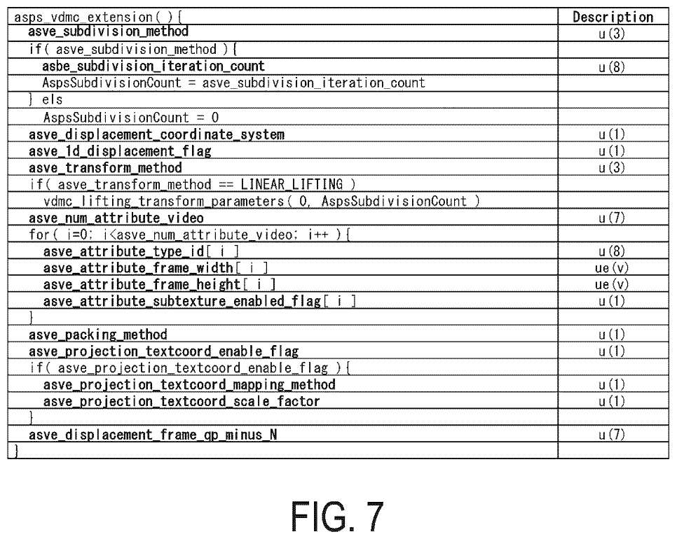

FIG. 7 is an example of syntax of an Atlas Sequence Parameter Set (ASPS) being a sequence-level parameter set. The ASPS is one of the NAL units of the atlas information, and includes syntax elements to be applied to a coded atlas information stream. Semantics of each field is as follows.

asve_subdivision_iteration_count: indicates the number of subdivision iterations of the mesh.

asve_displacement_coordinate_system: coordinate system conversion information indicating the coordinate system for mesh displacements. A value equal to a prescribed first value (for example, 0) indicates a Cartesian coordinate system. A value equal to a second value (for example, 1) different from the first value indicates a local coordinate system.

asve_1d_displacement flag: flag indicating whether or not the mesh displacement is one-dimensional. The value being true indicates that the mesh displacement is one-dimensional. The value being false indicates that the mesh displacement is three-dimensional.

### Decoding and Derivation of Picture/Frame-Level Control Parameters

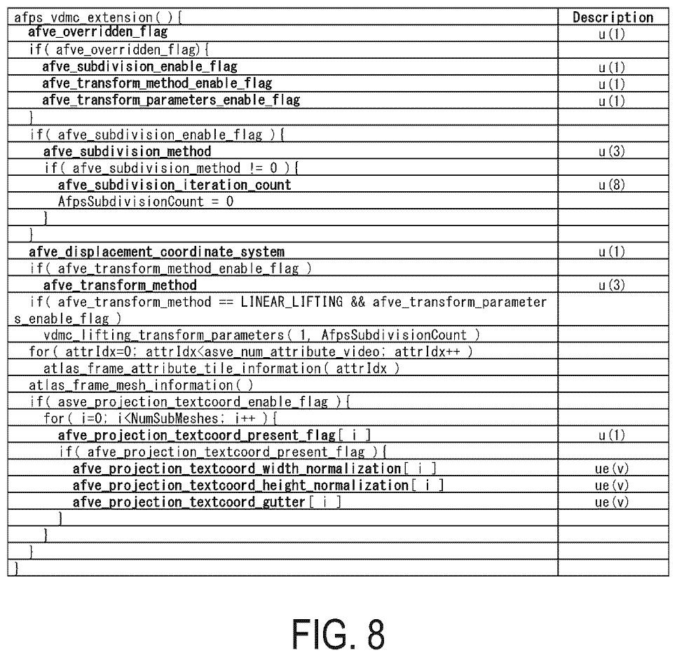

FIG. 8 is an example of syntax of an Atlas Frame Parameter Set (AFPS) being a picture/frame-level parameter set. The AFPS is one of the NAL units of the atlas information, and includes syntax elements to be applied to a coded atlas information stream. Semantics of each field is as follows. The AFPS includes atlas_frame_mesh_informationo.

afve_overriden_flag: flag indicating whether or not the coordinate system for mesh displacements is updated. In a case that the flag is equal to true, the coordinate system for mesh displacements is updated based on the value of afve_displacement_coordinate_system to be described later. In a case that the flag is equal to false, the coordinate system for mesh displacements is not updated.

afve subdivision iteration count: indicates the number of subdivision iterations of the mesh.

afve_displacement_coordinate_system: coordinate system conversion information indicating the coordinate system for mesh displacements. A value equal to a first value (for example, 0) indicates a Cartesian coordinate system. A value equal to a second value (for example, 1) indicates a local coordinate system. In a case that this syntax element is not present, the value is inferred to be a value decoded using the ASPS and a coordinate system indicated by the ASPS is set as a default coordinate system.

### Decoding and Derivation of Mesh-Level Control Parameters

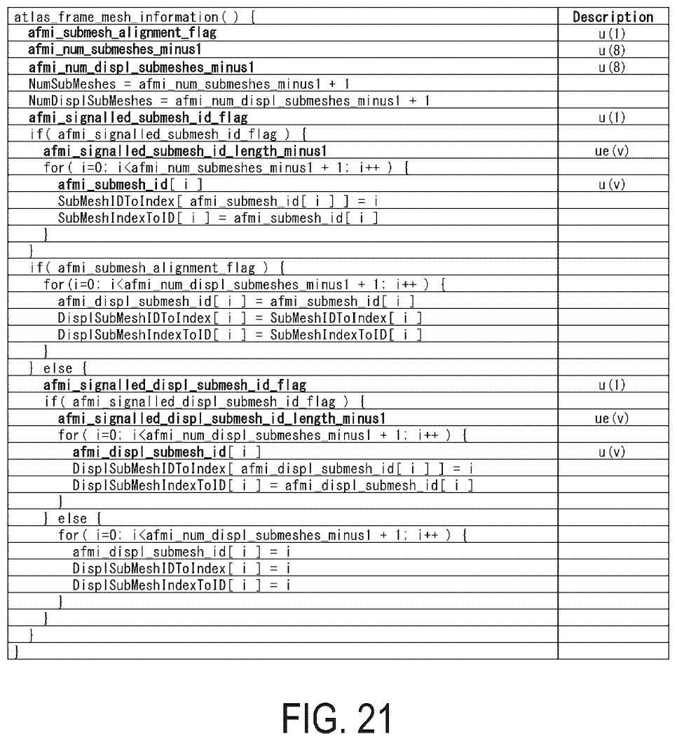

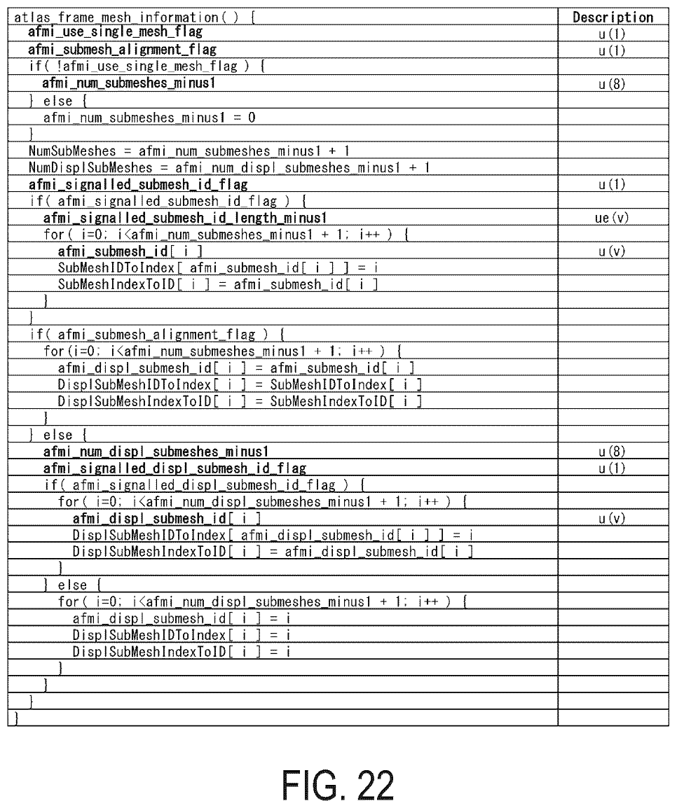

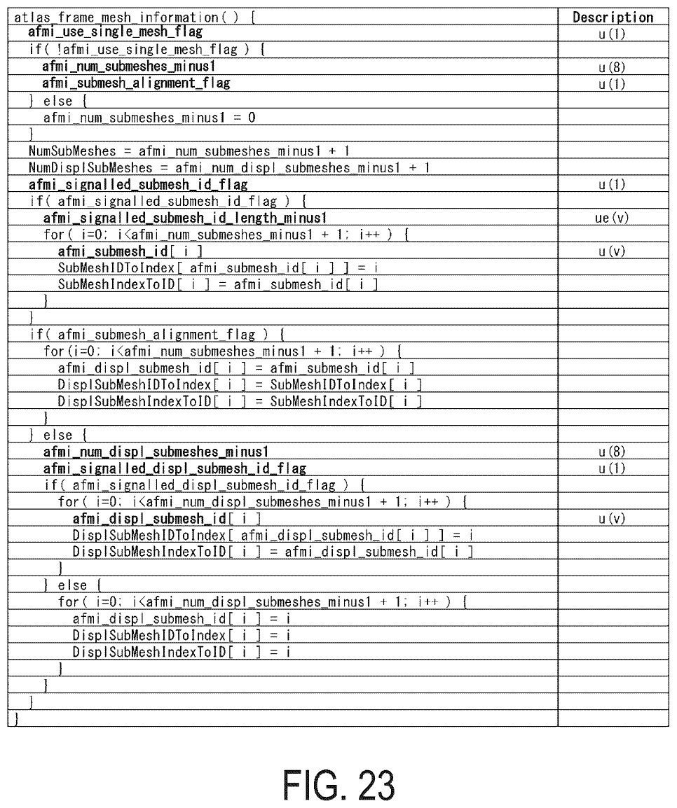

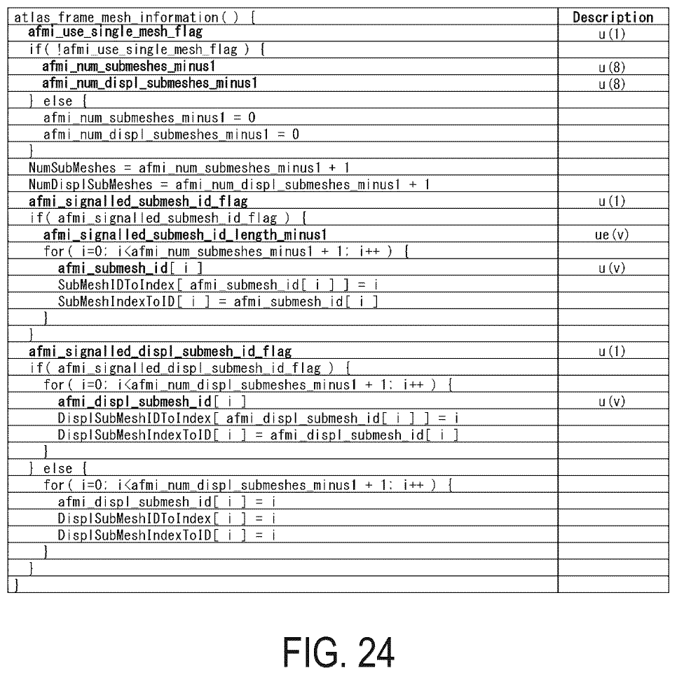

FIG. 21, FIG. 22, FIG. 23, and FIG. 24 are examples of syntax structures of atlas_frame_mesh_informationo for transmitting submesh information of a base mesh and a mesh displacement in the AFPS. In the example of the syntax structure of FIG. 21, the number of submesh IDs is coded and decoded regardless of the number of submeshes to be referred to. atlas_frame_mesh_informationo may include one of the following syntax elements. Semantics of each field is as follows.

afmi_use_single_mesh_flag: flag indicating whether or not there is only one submesh referred by mesh patches in each atlas frame referring to the AFPS. In a case that the value is true, it indicates that there is only one submesh referred by mesh patches. In a case that the value is false, it indicates that there may be more than one submeshes that are referred by mesh patches.

afmi_submesh_alignment_flag: flag indicating whether or not the submesh of the base mesh and the submesh of the mesh displacement correspond to each other. In a case that the value is true, it indicates that the submeshes of the base mesh and the mesh displacement correspond to each other. In a case that the value is false, it indicates that the submeshes of the base mesh and the mesh displacement may not correspond to each other. Here, the submesh of the base mesh and the submesh of the mesh displacement corresponding to each other means the vertex of the base mesh of the same ID and a corresponding vertex of the mesh displacement being present in the same region. One mesh set (submesh) can be decoded from the submesh of the base mesh and the submesh of the mesh displacement. The submesh of the base mesh and the submesh of the mesh displacement corresponding to each other means the numbers of submeshes being equal to each other. Thus, in a case of defining the submesh information of the mesh displacement in the AFPS, the value of afmi_num_submesh_minus1 may be used instead of afmi_num_displ_submesh_minus1, without encoding or decoding afmi_num_displ_submesh_minusi. The vertex of the base mesh of a certain submesh ID is referred to by the mesh displacement of the same submesh ID. Alternatively, the mesh displacement of a certain submesh ID may refer to only the vertex of the base mesh of the same submesh ID and decode the vertex. There may be a bitstream condition that the mesh displacement of a certain submesh ID refers to only the vertex of the base mesh of the same submesh ID.

afmi_num_submeshes_minus1: parameter indicating the number of submeshes referred by mesh patches. The number of submeshes is afmi_num_submeshes_minusl+1.

afmi_num_displ_submesh_minus1: parameter indicating the number of displacement submeshes referred by mesh patches. The number of submeshes is afmi_num_displ_submesh_minusl+1. In a case of not being present, the value of afmi_num_displ_submesh_minusi is inferred to be equal to afmi_num_submeshes_minusi.

afmi_signalled_submesh_id_flag: flag indicating whether or not the submesh ID to be referred to by the mesh patch is signaled. In a case that the value is true, it indicates that the submesh ID is signaled. In a case that the value is false, it indicates that the submesh ID is not signaled.

afmi_signalled_submesh_id_length_minus1: parameter indicating the number of bits of a syntax element pdu_submesh_id/bmpdu_submesh_id[tileID][patchIdx] in a case that there is a syntax element afmi_submesh_id[i] in an atlas tile with a tile ID being equal to tileID in a patch data unit having an index patchIdx. The value of afmi_signalled_submesh_id_length_minus1 shall be within a range of 0 to 15. In a case of not being present, the value is inferred to be equal to the following expression.

Ceil(Log2(afmi_num_submeshes_minus1+1))

afmi_submesh_id[i]: parameter indicating the submesh ID of an i-th submesh. In a case that the value of afmi_signalled_submesh_id_flag is true, the length of the syntax element of afmi_submesh_id[i] is afmi_signalled_submesh_id_length_minusl bits.

afmi_signalled_displ_submesh_id_flag: flag indicating whether or not the submesh ID to be referred to by the mesh displacement patch is signaled. In a case that the value is true, it indicates that the submesh ID is signaled. In a case that the value is false, it indicates that the submesh ID is not signaled. In a case that the value of afmi_use_single_mesh_flag is true, overhead for the amount of codes may be reduced with the value of afmi_signalled_displ_submesh_id_flag being invariably false.

afmi_displ_submesh_id: parameter indicating the submesh ID of an i-th displacement submesh. The number of length bits of the syntax element of afmi_displ_submesh_id is derived according to the following expression.

Ceil(Log2(afmi_num_displ_submeshes_minus1+1)) bits

The atlas information decoder 302 (submesh decoder 309) decodes frame mesh information from coded data of the AFPS of the atlas information. For example, afmi use_single_mesh_flag, afmi_num_submeshes_minus1, afmi_num_displ_submeshes_minus1, afmi_signalled_submesh_id_flag, afmi_signalled_displ_submesh_id_flag, afmi_signalled_submesh_id_length_minus1, afmi_signalled_displ_submesh_id_length_minus1, afmi_submesh_id, and afmi_displ_submesh_id are decoded. Furthermore, afmi_submesh alignment flag may be decoded. Only in a case that afmi_submesh_alignment_flag is false, the submesh information afmi_signalled_displ_submesh_id_length_minus1, afmi_submesh_id, and afmi_displ_submesh_id of the mesh displacement may be included, and decoding and coding may be performed. In other words, in a case that afmi_submesh_alignment_flag is true, the submesh information afmi_signalled_displ_submesh_id_length_minus1, afmi_submesh_id, and afmi_displ_submesh_id of the mesh displacement may not be included, and decoding and coding may not be performed. The atlas information encoder 101 (submesh encoder 116) codes frame mesh information into coded data of the AFPS of the atlas information.

In a case that afmi_signalled_submesh_id_flag is true, the submesh decoder 309 decodes afmi_submesh_id[i] as many as the number of submeshes (afmi_num_submeshes_minusI+1) within a range of i=0.. afmi_num_submeshes_minus1, and derives arrays SubMeshIDToIndex and SubMeshIndextoID regarding i=0.. afmi_num_submeshes_minus1 as follows.
SubMeshIDToIndex[.afml_submesh_id[i]]=i
SubMeshIndextoID[i]=afmi_submesh_id[i]

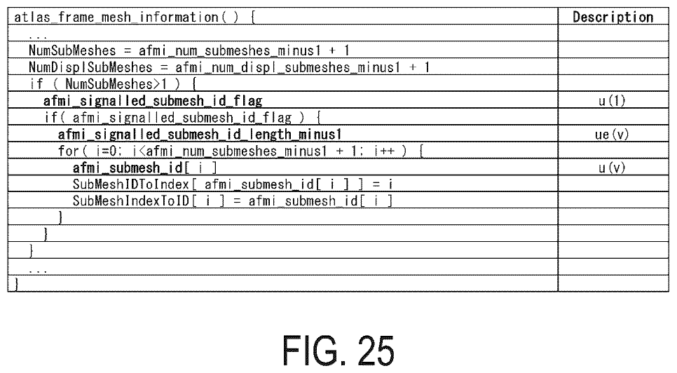

Note that, as in FIG. 25, in the syntax configurations of FIG. 21, FIG. 22, FIG. 23, and FIG. 24, only in a case of if (!afmi_use_single_mesh_flag), afmi_signalled_submesh_id_flag, if (afmi_signalled_submesh_id_flag), and the following { }part may be present. Alternatively, in a case that the number of submeshes (NumSubmeshes=afmi_num_submeshes_minus1+1) is greater than 1, the part may be present.

In this case, in a case that afmi use_single_mesh_flag is false (or the number of submeshes (NumSubmeshes=afmi_num_submeshes_minus1+1) is greater than 1) and afmi_signalled_submesh_id_flag is true, the submesh decoder 309 may decode afmi_signalled_submesh_id_length_minus1 and afmi_submesh_id[i] as many as the number of submeshes minus 1 (afmi_num_submeshes_minus1) within a range of i=0.. afmi_num_submeshes_minus1. In a case that afmi use_single_mesh_flag is true (or the number of submeshes (NumSubmeshes=afmi_num_submeshes_minus1+1) is 1), the ID may be invariably 0 as in SubMeshIDToIndex[0]=0 and SubMeshIndexToID[0]=0.

In the syntax configurations of FIG. 21, FIG. 22, FIG. 23, and FIG. 24, instead of the example of the syntax configuration of FIG. 25, in a case that the value of afmi_use_single_mesh_flag is true, the ID may be invariably 0 as in SubMeshIDToIndex[0]=0 and SubMeshIndexToID[0]=0, with the value of afmi_signalled_submesh_id_flag being invariably false.

In a case that afmi_signalled_submesh_id_flag is true, the submesh decoder 309 derives the arrays regarding i=0.. afmi_num_submeshes_minus1 as follows, without decoding afmi_submesh_id[i].
SubmeshIDToIndex[i]=i
SubMeshIndextoID[i]=i

In a case that afmi_submesh_alignment_flag is true, the submesh decoder 309 may derive the arrays regarding i=0.. afmi_num_displ_submeshes_minus1 as follows.
DisplSubMeshIDToEndex[i]=SubMeshIDToIndex[i]
DisplSubMeshIndextoID[i]=SubMeshIndextoID[i]

In a case that afmi_submesh_alignment_flag is true, instead of the arrays DisplSubMeshIDToIndex and DisplSubMeshIndextoID of the mesh displacement, SubMeshIDToIndex and SubMeshIndextoID common to the base mesh and the mesh displacement may be used.

In a case that afmi_signalled_displ_submesh_id_flag is true, the submesh decoder 309 decodes afmi_displ_submesh_id[i] as many as the number of submeshes (afmi_num_displ_submeshes_minus1+1) within a range of i=0.. afmi_num_displ_submeshes_minusi, and derives the arrays DisplSubMeshIDToIndex and DisplSubMeshIndextoID regarding i=0.. afmi_num_displ_submeshes_minus1 as follows.
DisplSubMeshIDToIndex[afmi_displ . . . submesh_id[i]]=i
DisplSubMeshIndextoID[i]=afmi_displ_submesh_id[i]

In a case that afmi_signalled_displ_submesh_id_flag equal to false, the submesh decoder 309 derives the arrays regarding i=0.. afmi_num_displ_submeshes_minus1 as follows, without decoding afmi_displ_submesh_id[i].
DisplSubMeshIDToIndex[i]=i
SisplSubMeshIndextoID[i]=i

In the present configuration, there is an effect that decoding and indication can be performed for each submesh unit also in the mesh displacement.

In the above configuration, in a case that afmi_submesh_alignment_flag equal to false, the submesh decoder 309 decodes information (afmi_signalled_displ_submesh_id_flag, afmi_signalled_displ_submesh_id_length_minus1, and afmi_displ_submesh_id[i]) of the submesh related to the mesh displacement, and in a case that afmi_submesh_alignment_flag equal to true, the submesh decoder 309 does not decode the information of the submesh related to the mesh displacement.

In the configuration of decoding and encoding afmi_submesh_alignment_flag, whether the submeshes of the base mesh and the mesh displacement are the same or different can be determined with reference to the flag, and therefore there is an effect that decoding and indication for each submesh unit are easily performed. This allows for omission of coding of arrays, and can thus reduce the amount of codes as well.

### Other Configurations

In the configuration illustrated in FIG. 22, in a case that the value of afmi_submesh_alignment_flag equal to false, the submesh decoder 309 further decodes afmi_num_displ_submeshes_minus1 as the information of the submesh related to the mesh displacement, and in a case that the value of afmi_submesh_alignment flag equal to true, the submesh decoder 309 does not decode afmi_num_displ_submeshes_minus1 as the information of the submesh related to the mesh displacement.

In the present configuration, in a case that the value of afmi_submesh alignment flag equal to true, afmi_num_displ_submeshes_minus1 is not decoded as the information of the submesh related to the mesh displacement, and therefore there is an effect that overhead for the amount of codes is reduced.

In the configuration illustrated in FIG. 23, in a case that the value of afmi_use_single_flag equal to false, the submesh decoder 309 decodes afmi_submesh_alignment_flag, and in a case that the value of afmi_use_single_flag equal to true, the submesh decoder 309 does not decode afmi_submesh_alignment_flag.

In the present configuration, in a case that the value of afmi_use_single_flag equal to true, afmi_submesh_alignment_flag is not decoded, and therefore there is an effect that overhead for the amount of codes is reduced.

Alternatively, instead of the examples of the syntax structures of FIG. 21, FIG. 22, FIG. 23, and FIG. 24, the submesh decoder 309 may invariably derive the arrays as follows, without decoding or coding afmi_submesh_alignment flag.
DisplSubMeshIDToIndex[i] SubMeshIDToIndex[i]
DisplSubMeshIndextoID[i]=SubMeshIndextoID[i]

In other words, the submesh of the base mesh and the submesh of the mesh displacement may be made to invariably correspond to each other. In this case, the submesh information decoded with the base mesh is also used in decoding of the mesh displacement.

In the present configuration, there is not a degree of freedom of making the submeshes of the base mesh and the mesh displacement different from each other; however, because the decoding side knows in advance that it is invariably the same mesh subdivision, there is an effect that decoding and indication for each submesh unit are easily performed.

In the configuration illustrated in FIG. 25, the submesh decoder 309 decodes and encodes the submesh information of the mesh displacement invariably independent of the submesh of the base mesh, without decoding or encoding afmi_submesh_alignment_flag.

In the present configuration, because the submeshes of the base mesh and the mesh displacement do not have dependency, mesh reconstruction cannot be performed for each submesh unit; however, because the base mesh and the mesh displacement can be invariably independently decoded and encoded, there is an effect that the submeshes are easily decoded and encoded in parallel.

Instead of the examples of the syntax structures of FIG. 21, FIG. 22, FIG. 23, and FIG. 24, in a case of decoding and encoding afmi_use_single_mesh_flag, the submesh decoder 309 may decode and encode syntax elements afmi_num_submeshes_minus2 and afmi_num_displ_submeshes_minus2 indicating the number of submeshes minus 2 (a value obtained by subtracting 2 from the number of submeshes). Alternatively, only in a case that the value of afmi_use_single_mesh_flag equal to false, the syntax elements afmi_num_submeshes_minus2 and afmi_num_displ_submeshes_minus2 indicating the number of submeshes to be referred to minus 2 may be decoded and encoded. The following example may be used for semantics.

afmi_num_submeshes_minus2: parameter indicating the number of submeshes referred by mesh patches. The number of submeshes is afmi_num_submeshes_minus2+2.

afmi_num_displ_submeshes_minus2: parameter indicating the number of displacement submeshes referred by mesh patches. The number of submeshes is afmi_num_displ_submeshes_minus2+2. In a case that afmi_num_displ_submesh_minus2 is not present, the value of afmi_num_displ_submesh_minus2 is inferred to be equal to afmi_num_submeshes_minus2.

In the present configuration, a case that the number of submeshes to be referred to is one can be expressed by afmi_use_single_mesh_flag, and therefore there is an effect that overhead for the amount of codes is reduced by decoding and encoding the syntax element indicating the number of submeshes minus 2.

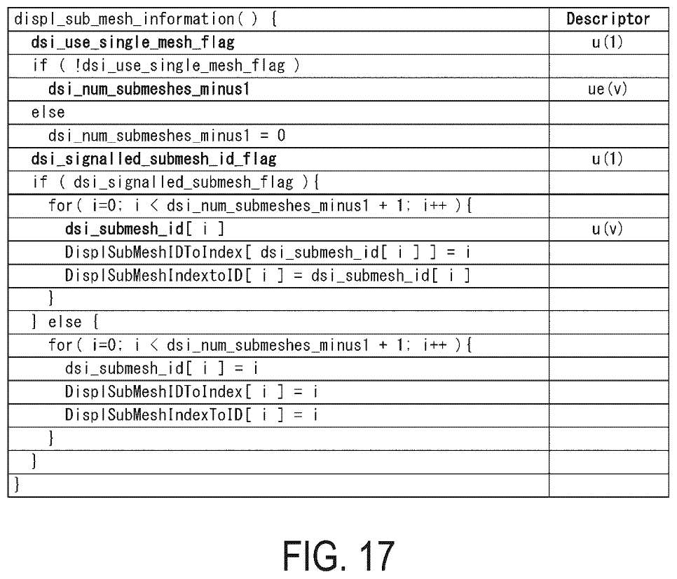

Instead of the examples of the syntax structures of FIG. 21, FIG. 22, FIG. 23, and FIG. 24, in a case that the value of afmi_submesh_alignment_flag is false, or the submesh information of the mesh displacement invariably independent of the submesh information of the base mesh is decoded and encoded, the submesh decoder 309 may decode and encode the submesh information of the mesh displacement, using not atlas_frame_mesh_informationo but the example of the syntax structure of the mesh displacement of FIG. 17 to be described later.

### Syntax Structure of Mesh Displacement

In the 3D data coding scheme of NPL 1, the mesh displacement (displacement data) is coded and decoded at a frame level; however, there is a problem in that the mesh displacement cannot be coded and decoded using the submesh information indicating a unit of subdividing a frame into multiple meshes. In other words, there is a problem in that a base mesh encoder 103 and the base mesh decoder 303 that independently perform coding and decoding for each submesh and a mesh displacement encoder 107 and the mesh displacement decoder 305 that perform coding and decoding for each frame can process mesh reconstruction only at a frame level and cannot process the mesh reconstruction at a submesh level.

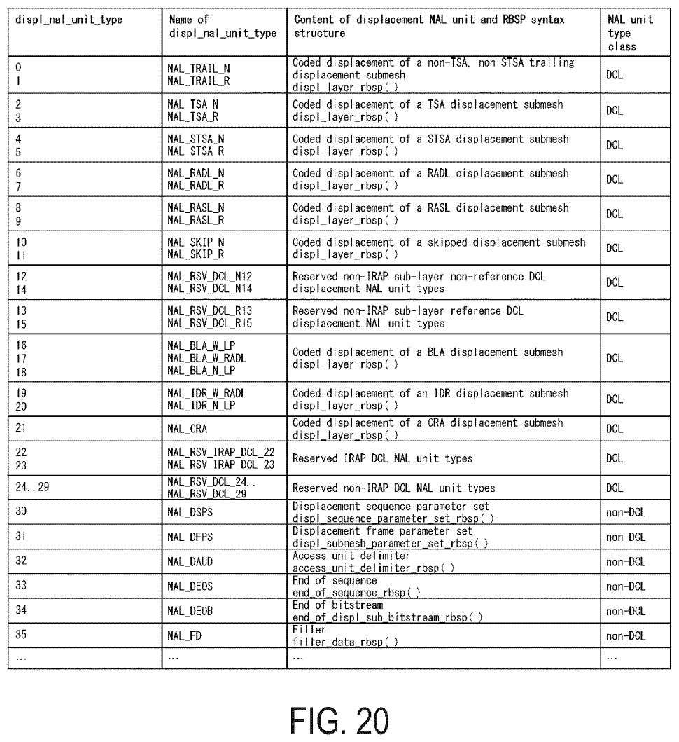

As will be illustrated in the syntax structure to be described later, the present example has the NAL unit type of FIG. 20. In other words, the mesh displacement is decoded at a submesh level.

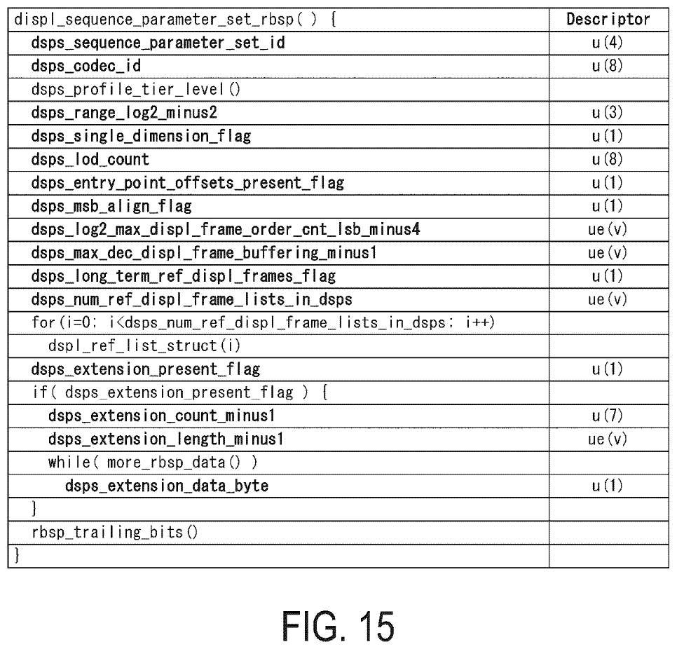

FIG. 15 is an example of syntax of a configuration for transmitting mesh displacement parameters at a sequence-level DSPS. The Displacement Sequence Parameter Set (DSPS) is one of the NAL units of the mesh displacement, and includes syntax elements to be applied to a coded mesh displacement stream. Semantics of each field is as follows.

dsps_sequence_parameter_set_id: indicates an identifier of a mesh displacement sequence parameter set for other syntax elements to refer to.

dsps_single_dimension_flag: flag indicating whether or not the mesh displacement is one-dimensional. The value being true indicates that the mesh displacement is one-dimensional.

The value being false indicates that the mesh displacement is three-dimensional. dsps_lod_count: indicates the number of Levels of Detail (LoDs) of the mesh displacement. Note that the number of LoDs minus 1 (dsps_lod_count_minus1) may be coded and decoded. In that case, dsps_lod_count=dsps_lod_count_minusl+1 is used.

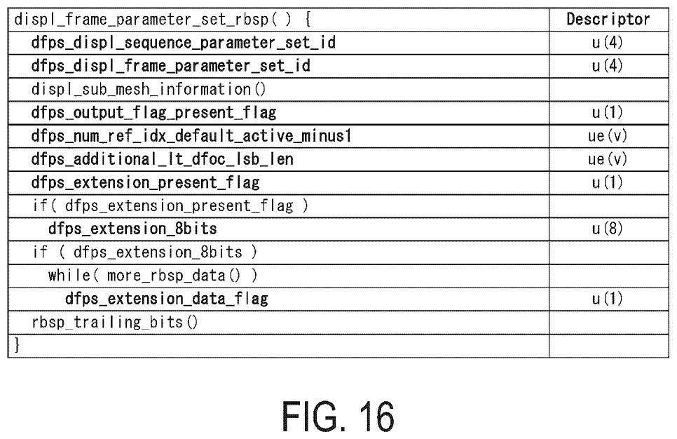

FIG. 16 is an example of syntax of a configuration for transmitting mesh displacement parameters in a Displacement Frame Parameter Set (DFPS) being a picture/frame-level parameter set. The DFPS is one of the NAL units of the mesh displacement, and includes syntax elements to be applied to a coded mesh displacement stream. Semantics of each field is as follows.

dfps_displ_sequence_parameter_set_id: indicates the value of dsps_sequence_parameter_set_id of an active mesh displacement sequence parameter set.

dfps_displ_frame_parameter_set_id: indicates an identifier of a mesh displacement frame parameter set for other syntax elements to refer to.

The mesh displacement decoder 305 and the mesh displacement encoder 107 decode dfps_displ_sequence_parameter_set_id and dfps_output_flag_present flag from coded data of the DFPS, and code into coded data of the DFPS.

FIG. 17 is an example of a syntax structure of displ_sub_mesh_informationo to be transmitted in the DFPS. Semantics of each field is as follows. displ_sub_mesh_information( ) is submesh information indicating a unit of subdividing a frame into multiple meshes. The submesh information may include the number of submeshes, IDs of the submeshes, and code lengths of the submesh IDs.

dsi use_single_mesh_flag: in a case that dsi_use_single_mesh_flag is equal to 1, it indicates that only one submesh is present in each mesh frame referring to the DFPS. In a case that dsi_use_single_mesh_flag is equal to 0, it indicates that multiple submeshes may be present in each mesh frame referring to the DFPS.

dsi_num_submeshes_minus1: indicates the number of submeshes in each mesh frame referring to the DFPS minus 1. In a case that dsi_use_single_mesh_flag is equal to 1, the number of dsi_num_submeshes_minusl+1 is inferred to be equal to 1.

dsi_signalled_submesh_id_flag: in a case that dsi_signalled_submesh_id_flag is equal to 1, it indicates that the submesh ID of each mesh frame is signaled. In a case that dsi_signalled_submesh_id_flag is equal to 0, it indicates that the submesh ID is not signaled.

dsi_submesh_id: dsi_submesh_id[i] indicates an i-th submesh ID. The length (number of bits) of the dsi_submesh_id[i] syntax element is derived according to the following expression.

Ceil(Log2(dsi_num_displ_submeshes_minus1+1)) bits

The mesh displacement decoder 305 decodes mesh displacement submesh information from coded data of the DFPS. For example, dsi_use_single_mesh_flag, dsi_num_submeshes_minus1, dsi_signalled_submesh_id_flag, dsi_signalled_submesh_id_length_minus1, and dsi_submesh_id are decoded. The mesh displacement encoder 107 codes mesh displacement submesh information into coded data of the DFPS.

In a case that dsi_signalled_submesh_id_flag is true, the mesh displacement decoder 305 decodes dsi_submesh_id[i] as many as the number of submeshes (dsi_num_submeshes_minus1+1) within a range of i=0.. dsi_num_submeshes_minusi, and derives the arrays DisplSubMeshIDToIndex and DisplSubMeshIndextoID regarding i=0.. dsi_num_submeshes_minusi as follows.
DisplSubMeshIDToIndex[dsi_submesh_id[i]]=i
DisplSubMeshIndextoID[i]=dsi_submesh_id[i]

In a case that dsi_signalled_submesh_id_flag is false, the mesh displacement decoder 305 derives the arrays regarding i=0.. dsi_num_submeshes_minus1 as follows, without decoding dsi_submesh_id[i].
DisplSubMeshIDToIndex[i]=i
DisplSubMeshIndextoID[i]=i

Instead of the example of the syntax structure of FIG. 17, in a case of decoding and coding dsi_use_single_mesh_flag, a syntax element dsi_num_displ_submeshes_minus2 indicating the number of submeshes minus 2 (a value obtained by subtracting 2 from the number of submeshes) may be decoded and encoded. Alternatively, only in a case that the value of dsi_use_single_mesh_flag is false, the syntax element dsi_num_displ_submeshes_minus2 indicating the number of submeshes to be referred to minus 2 may be decoded and encoded. The following example may be used for semantics.

dsi_num_displ_submeshes_minus2: parameter indicating the number of submeshes in each mesh frame referring to the DFPS. The number of submeshes is dsi_num_displ_submeshes_minus2+2. In a case that dsi_use_single_mesh_flag is equal to 1, the number of dsi_num_submeshes_minus2+2 is inferred to be equal to 1.

In the present configuration, a case that the number of submeshes to be referred to is one can be expressed by dsi_use_single_mesh_flag, and therefore there is an effect that overhead for the amount of codes is reduced by decoding and coding the syntax element indicating the number of submeshes minus 2.

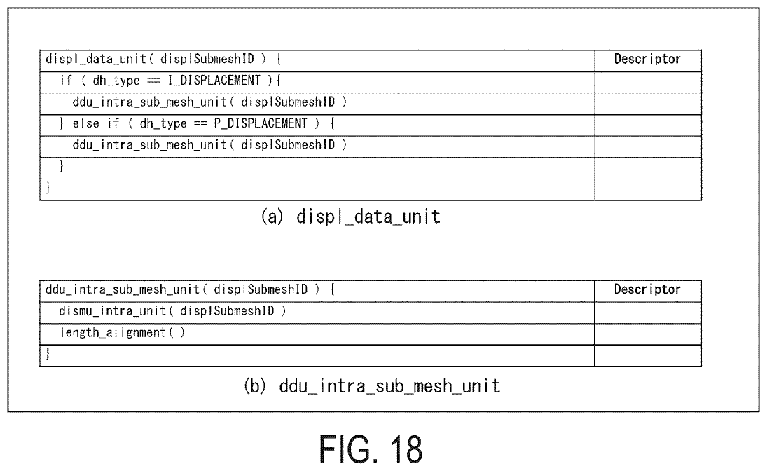

Although not illustrated, the mesh displacement decoder 305 and the mesh displacement encoder 107 may decode and encode a displacement layer displ_layer_rbspo including a displacement header displ_headero, displacement data displ_data_unit (displ id), and rbsp_trailing_bitso from coded data. The displacement data displ_data_unit (displ_id) may be a syntax structure to be described later in FIG. 18.

The mesh displacement decoder 305 and the mesh displacement encoder 107 may decode and encode the following syntax from the displacement header displ_headero.

dh_frame_parameter_set_id: indicates the ID of the parameter set.

displ_submesh_id: indicates the ID of the submesh of the mesh displacement.

dh_type: coding type of the mesh displacement. It indicates an intra-coding (I DISPLACEMENT) or inter-coding (P DISPLACEMENT) type. st may be used as a variable indicating a submesh type. It may be used as st=dh_type.

dh_output flag: flag indicating whether output is performed.

dh_frm_order_cnt_lsb: value of the least significant bit (LSB) of a Picture Order Cnd (POC).

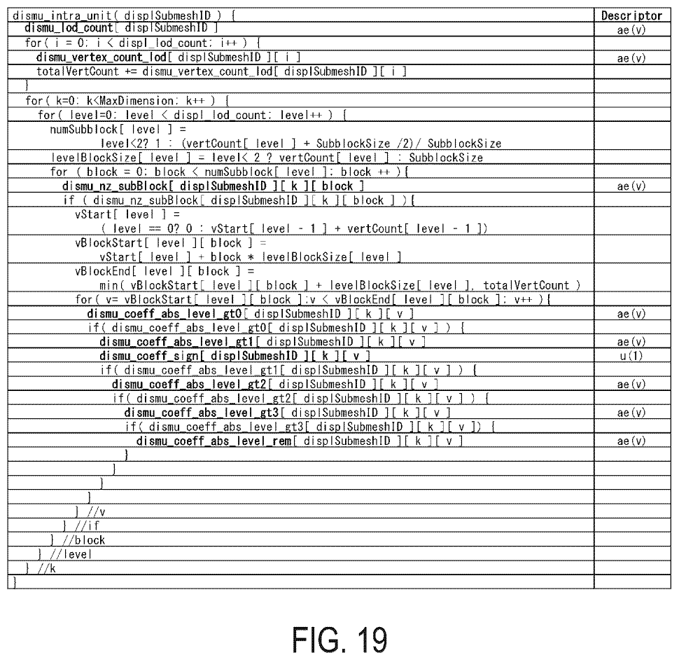

FIG. 18 and FIG. 19 are examples of syntax structures of the mesh displacement.

Semantics of is as follows. The mesh displacement is a column of values (coefficients) of a submesh ID (subMeshID), a position level, and a k component, and is represented by an array Qdisp[subMeshID][level][k]. The displacement is a three-dimensional signal in the Cartesian coordinate system (xyz) or the local coordinate system (ntb), and each component of the three-dimensional displacement is referred to as a component. Here, a displacement Qdisp is a value resulting from discrete wavelet transformed, lifting transform, DCT transform, or the like, and is also referred to as a coefficient. The component variable k is a value of 0, 1, or 2. The variable name is not limited to k, and may be another variable name such as dim. The order of indices of QDisp may be reversed, that is, Qdisp[subMeshID][k][level] may be used instead of Qdisp[subMeshID][level][k]. As in the example of the syntax structure of part (a) of FIG. 18, a syntax structure ddu_intra_sub_mesh_unit (displSubmeshID) of part (b) of FIG. 18 may be used regardless of the coding type of the mesh displacement. Alternatively, depending on the coding type, ddu_intra_sub_mesh unit (displSubmeshID) and ddu_inter_sub_mesh unit (displSubmeshID) may be used as follows.

```
disp [symbol] _data_unit( disp [symbol] SubmeshID ) [symbol]
  if( dh_type == [symbol] _DISPLACEMENT) [symbol]
    ddu_intra_sub_mesh_unit ( disp [symbol] SubmeshID )
  } else if( df_type == P_DISPLACEMENT ) [symbol]
    ddu_inter_sub_mesh_unit ( disp [symbol] SubmeshID )
  }
} [symbol]
indicates data missing or illegible when filed
```

Here, ddu_inter_sub_mesh unit (displSubmeshID) may use a syntax structure in which a target mesh displacement to be decoded performs motion compensation by referring to another mesh displacement.

The mesh displacement decoder 305 decodes the syntaxes illustrated in FIG. 18 and FIG. 19 for each submesh unit indicated by displSubMeshID. For example, as illustrated below, the number of displacement coefficients, absolute values of the displacement coefficients, codes of the displacement coefficients, and the like may be decoded for each displSubMeshID. Note that displSubMeshID may use the value displ_submesh_id of the displacement header displ_headero.

As another aspect, displSubMeshID may use a value obtained by decoding the syntax element dsi_submesh_id[i] included in displ_sub_mesh_informationo.

displSubMeshID=dsi_submesh_id[i]

In a case of decoding multiple submesh displacements indicated by index i, using an array already decoded or derived, an ID (=displSubMeshID) may be derived from the index i to be used.

displSubMeshID=DisplSubMeshIndextoID[i]

Regarding the index i, the mesh displacement decoder 305 and the mesh displacement encoder 107 may perform loop processing related to i, and decode and encode the displacement header displ_headero and the displacement data displ_data_unit (displ_id).

As another configuration, the mesh displacement decoder 305 and the mesh displacement encoder 107 may decode and encode one displacement header displ_headero, further perform loop processing related to i, and decode and encode the displacement data displ_data_unit (displ_id). In the displacement data, a value decoded and encoded using one displ_headero is used in common.

The syntax elements of FIG. 19 have the following meanings.

dismu_vertex_count lod[displSubMeshID][i]: indicates the number of coordinates (displacements) included in subdivision (LoD) level i. As in vertCount[i]=dismu_vertex_count_lod[i], the number vertCount of blocks i may be derived.

dismu_coeff_abs_level_gt0[displSubmeshID][k][v]: indicates whether or not an absolute value of a non-zero mesh displacement coefficient at a vertex of index v of a component of index k is greater than 0 in the submesh of displSubmeshID. In a case of being greater, the value is 1, and otherwise the value is 0.

dismu_coeff_abs_level_gtl[displSubmeshID][k][v]: indicates whether or not the absolute value of the non-zero mesh displacement coefficient at the vertex of the index v of the component of the index k is greater than 1 in the submesh of displSubmeshID. In a case of being greater, the value is 1, and otherwise the value is 0. In a case that the syntax is not present, the value is inferred to be 0.

dismu_coeff_abs_level_gt2[displSubmeshID][k][v]: indicates whether or not the absolute value of the non-zero mesh displacement coefficient at the vertex of the index v of the component of the index k is greater than 2 in the submesh of displSubmeshID. In a case of being greater, the value is 1, and otherwise the value is 0. In a case that the syntax is not present, the value is inferred to be 0.

dismu_coeff_abs_level_gt3[displSubmeshID][k][v]: indicates whether or not the absolute value of the non-zero mesh displacement coefficient at the vertex of the index v of the component of the index k is greater than 3 in the submesh of displSubmeshID. In a case of being greater, the value is 1, and otherwise the value is 0. In a case that the syntax is not present, the value is inferred to be 0.

dismu_coeff sign[displSubmeshID][k][v]: indicates whether or not the non-zero mesh displacement coefficient at the vertex of the index v of the component of the index k is a positive number in the submesh of displSubmeshID. In a case of being a positive number, the value is 1, and otherwise (in a case of being a negative number) the value is 0. In a case that the syntax is not present, the value is inferred to be 1.

dismu_coeff_abs_level_rem[displSubmeshID][k][v]: value obtained by subtracting 4 from the absolute value of the non-zero mesh displacement coefficient at the vertex of the index v of the component of the index k in the submesh of displSubmeshID. In a case that the syntax is not present, the value is inferred to be 0.

The mesh displacement decoder 305 decodes dismu_nz_subBlock for each subblock of the mesh displacement. In a case that dismu_nz_subBlock[displSubmeshID][k][block] is 1, the following syntax elements are decoded in the component of the index k and at a subblock level of index block.

The mesh displacement decoder 305 decodes dismu_coeff_abs_level_gt0 for each subblock of the mesh displacement, and in a case that dismu_coeff_abs_level_gt0 is a prescribed value (for example, other than 0), decodes the following dismu_coeff sign and dismu_coeff_abs_level_gtl.

In a case that dismu_coeff_abs_level_gtl is a prescribed value (for example, other than 0), the mesh displacement decoder 305 decodes the following dismu_coeff_abs_level_gt2.

In a case that dismu_coeff_abs_level_gt2 is a prescribed value (for example, other than 0), the mesh displacement decoder 305 decodes the following dismu_coeff_abs_level_gt3.

In a case that dismu_coeff_abs_level_gt3 is a prescribed value (for example, other than 0), the mesh displacement decoder 305 decodes the following dismu_coeff_abs_level_rem.

### Operation of Mesh Displacement Decoder

The arithmetic decoder 3051 decodes the coded mesh displacement stream arithmetically coded according to a value (context) indicating a random variable, and outputs a binary signal.

The binary signal may be an alpha code, or may be a k-th order exponential Golomb code (k-th order Exp-Golomb-code). The exponential Golomb code includes prefix and suffix codes. The prefix is an exponentially increasing value and the suffix is its remainder. Note that, in a case that a variable rem is coded and decoded using the exponential Golomb code, the prefix and the suffix of the exponential Golomb code are also referred to as the prefix and the suffix of rem.

The de-binarization unit 3052 decodes the binary signal to obtain a quantized mesh displacement Qdisp, which is a multi-valued signal.

The context selection unit 3056 (context memory) includes a memory for holding a context, derives a context used for arithmetic decoding of the mesh displacement depending on a state, and updates the value as necessary. Depending on a submesh type dh_type (for example, 0: intra-submesh, 1: inter-submesh), the level lod (level of detail) of mesh subdivision and the component dim of a mesh displacement vector, arithmetic decoding of each coefficient of the mesh displacement may use the following different context arrays. The context includes a variable indicating the probability of occurrence of a binary signal.
etxCodedSubBlock[numST][numLOD][numDim]
etxCoeffGtN[numST][numLOD][MAX_GTN+1][numDim]
etxCoeffRemPrefix[numST][numLOD][numDim][numPrefixBin]

Note that a static context with a fixed probability without context update is referred to as a ctxStatic. The syntax element indicated by ctxStatic may be decoded without using a context. decode(ctxStatic) may use dedicated processing for bypass as decode bypasso.

Here, numST is the number of types of submesh types, and numST may be 2. numPrefixBin is the number of bins using a context in the prefix, and numPrefixBin may be 2. numLOD is a maximum number of levels of detail of mesh subdivision, and numLOD may be 4. numDim is the number of dimensions of the mesh displacement vector, and numDim may be 3.

The maximum value MAX_GTN of a threshold for the coefficient is 3. ctxCodedSubBlock[numST][numLoD][numDim] is an array of contexts used to decode the syntax element dismu_nz_subBlock. The arithmetic decoder 3051 decodes dismu_nz_subBlock in the submesh type st, the level of detail lod, and the dimension dim of the mesh displacement vector, using the value of ctxCodedSubBlock[st][lod][dim].

ctxCoeffGtN[numST][numLoD][MAX_GTN+1][numDim] is an array of contexts used to decode the syntax element dismu_coeff_abs_level_gtN (N is replaced by 0, 1, 2, or MAX_GTN). The arithmetic decoder 3051 decodes dismu_coeff_abs_level_gtN in the submesh type st, the level of detail lod, and the dimension dim of the mesh displacement vector, using the value of ctxCoeffGtN[st][lod][N][dim].

The arithmetic decoder 3051 decodes dismu_coeff sign in the submesh type st, the level of detail lod, and the dimension dim of the mesh displacement vector, using a bypass.

ctxCoeffRemPrefix[numST][numLoD][numDim] is an array of contexts used to decode the syntax element dismu_coeff_abs_level_rem. The arithmetic decoder 3051 decodes dismu_coeff_abs_level_rem in the submesh type st, the level of detail lod, and the dimension dim of the mesh displacement vector, using the value of ctxCoeffRemPrefix[st][lod][dim]. As st, dh_type decoded from coded data may be used (the same applies hereinafter).

The context initialization unit 3057 initializes a context (probability of occurrence of a binary signal). The context may be initialized for each submesh, or the context may be initialized for each set of multiple submeshes. In a case that the context is initialized for each submesh, random access to any submesh can be easily performed because the submeshes do not have dependency on the context. In a case that the context is initialized for each set of multiple submeshes, coding efficiency can be further enhanced because of the lower frequency of initialization, in comparison to the case of initialization for each submesh.

### Processing of Deriving Mesh Displacement

The mesh displacement decoder 305 decodes the syntax elements dismu_nz_subBlock, dismu_coeff_abs_level_gt0, dismu_coeff_abs_level_gtl, dismu_coeff_abs_level_gt2, dismu_coeff_abs_level_gt3, dismu_coeff_abs_level_rem, and dismu_coeff sign, and derives the mesh displacement Qdisp, by using the following processing. Here, a restriction may be imposed on the submeshes of the base mesh decoder 303 and the submeshes of the mesh displacement decoder 305 to have correspondence, using the syntax element afmi_submesh_alignment_flag decoded from atlas_frame_mesh_information( ) illustrated in FIG. 21, FIG. 22, FIG. 23, and FIG. 24.

Here, the mesh displacement decoder 305 decodes dismu_nz_subBlock for each subblock having SubBlockSize. In a case that dismu_nz_subBlock is a prescribed value, the mesh displacement coefficient in the subblock is decoded. Decoding may be performed for each submesh unit indicated by subMeshID (=displSubMeshID). As st, dh type decoded from coded data may be used.

```
for (k = 0; k < numDim; k++) [symbol]  // dimension (component) loop
  for (b = 0; b [symbol]  b++) [symbol]  // Level of Detail loop, block loop
    numSubBlocks = dispCoubt[b] / subBlockSize + 1
    for ( [symbol]  = 0; [symbol]  numSubBlocks; [symbol] ++) [symbol]  // subblock loop
      // decode [symbol] [symbol]
      = decode( [symbol] txCodedSubBlock [symbol] )
      if ( [symbol] ) [symbol]
        for ( [symbol]  = 0; [symbol]  < subBlockSize; [symbol] ++) { // coefficient loop within

[symbol]

[symbol]

          value = 0
          // decode dismu_coeff_abs_level_gt0
          dismu_coeff_abs_level_gt0[k] [symbol]
            = decode( [symbol] )
          if (dismu_coeff_abs_level_gt0 [symbol] ) [symbol]
            value++
            // decode dismu_coeff_sign
            dismu_coeff_sign [symbol]  = decode( [symbol] txStatic)
            // decode dismu_coeff_abs_level_gt [symbol]
            dismu_coeff_abs_level_gt [symbol]
              = decode ( [symbol] txCoeffGtN [symbol] )
            if (dismu_coeff_abs_level_gt [symbol]
              value++
              // decode dismu_coeff_abs_level_gt2
              dismu_coeff_abs_level_gt2 [symbol]
                = decode( [symbol] txCoeffGtN [symbol] )
              if (dismu_coeff_abs_level_gt2 [symbol]
                value++
                // decode dismu_coeff_abs_level_gt3
                dismu_coeff_abs_level_gt3 [symbol]
                  = decode( [symbol] txCoeffGtN [symbol] )
                if (dismu_coeff_abs_level_gt3 [symbol]
                  // decode dismu_coeff_abs_level [symbol]
                  dismu_coeff_abs_level_ [symbol]
                    = decode [symbol]
                  value += (1 + dismu_coeff_abs_level [symbol]
                }
              }
            }
            if (dismu_coeff_sign [symbol]
              value = [symbol] value
            }
          }
          Qdisp[ [symbol] ][dispOffset + [symbol]  * subBlockSize + [symbol] ][k] = value
        }
      }
    }
    dispOffset += dispCount[b]
  }
} [symbol]
indicates data missing or illegible when filed
```

Here, decode(ctx) is a function for decoding a 1-bit value with a corresponding context ctx being an argument, and decodeExpGolomb(ctxPrefix, ctxSuffix) is a function for decoding a value binarized using a k-th order Golomb code (for example, k=0). ctxPrefix[n] is used as a context of the prefix at a bin position n, and ctxSuffix[m] is used as a context of the suffix at a bin position m. In a case that a context is not used for the suffix (a bypass is used), it is simply expressed as decodeExpGolomb(ctxPrefix). value++is an operation of incrementing a variable value by 1, value+=1, and value=value+1. subBlockSize is the size of the subblock. for indicates a loop. subBlockSize may use a value of a power of 2 from 16 to 4096. For example, it may be 128 or 256. dispCount[b] is the number of mesh displacements of the level of detail b.

Instead of using the above-described pseudocode method, the mesh displacement decoder 305 may derive value of the mesh displacement from dismu_coeff_abs_level_gt0, dismu_coeff_abs_level_gtl, dismu_coeff_abs_level_gt2, dismu_coeff_abs_level_gt3, dismu_coeff_abs_level_rem, and dismu_coeff_level_sign as follows. value is stored in QDisp. Decoding may be performed for each submesh unit indicated by subMeshID (displSubMeshID).

$$absCoeff = dismu\_coeff \_abs \_level \_gt0 + dismu\_coeff \_abs \_level \_gt1 + dismu\_coef$$

$$f\_abs \_level \_gt2 + dismu\_coeff \_abs \_level \_gt3 + dismu\_coeff \_abs \_level \_rem$$

$$value = absCoeff * ( 1 - 2 * dismu\_coeff \_sign )$$

Alternatively, the mesh displacement decoder 305 may decode the syntax elements dismu_nz_subBlock, dismu_coeff_abs_level_gtN, dismu_coeff_abs_level_rem, and dismu_coeff_sign, and derive the mesh displacement Qdisp, by using the following processing.

```
  for (k = 0 [symbol]  k [symbol]  numDim [symbol]  k++) [symbol]  // dimension [symbol] component [symbol]  loop
    dispOffset = 0
    for (b = 0; b [symbol]  b++) [symbol]  // Level of Detail loop, block loop
    numSubBlocks = dispCount[b] / subBlockSize + 1
    for (s = 0; s [symbol]  numSubBlocks; s++) [symbol]  // subblock loop
      // decode dimu_nz_subBlock
      dismu_nz_subBlock [symbol]  = decode( [symbol] txCodedSubBlock [symbol] )
      if (dismu_nz_subBlock [symbol] ) [symbol]
        for ( [symbol]  = 0 [symbol]  subBlockSize [symbol] ) [symbol]  // coefficient loop within

[symbol]

[symbol]

          value = 0
          // decode dismu_coeff_abs_level_gt0
          dismu_coeff_abs_level_gt0 [symbol]
            = decode( [symbol] txCoeffGtN [symbol] )
          if (dismu_coeff_abs_level_gt0 [symbol]
            // decode dismu_coeff_sign
            dismu_coeff_sign [symbol]  = decode( [symbol] txStatic) [symbol]
            = 1
            maxGtN = 3
            while (N <= maxGtN) [symbol]
              value++
              // decode dismu_coeff_abs_level_gtN [symbol]
              dismu_coeff_abs_level_gtN [symbol]
                = decode( [symbol] txCoeff [symbol] )
              if ( [symbol] dismu_coeff_abs_level_gtN [symbol] ) break
              N++

[symbol]

            if (dismu_coeff_abs_level_gtN [symbol] ) [symbol]
              // decode dismu_coeff_abs_level_ [symbol]
              dismu_coeff_abs_level_ [symbol]
                = decodeEx [symbol] ( [symbol] txCoeffRemPrefix [symbol] )
              value += ( [symbol]  + dismu_coeff_abs_level [symbol]
            }
            if (dismu_coeff_sign [symbol]
              value = [symbol] value
            }
          }
          Qdisp[displSubMeshID] [symbol]
        }
      }
    }
    dispOffset += dispCount [symbol]
  }
} [symbol]
indicates data missing or illegible when filed
```

break in pseudocode means skipping the following operation and exiting the latest loop.

Note that maxGtN is not limited to 3, and for example, maxGtN=2 may be used to code/decode the syntax elements dismu_coeff_abs_level_gt0, dismu_coeff_abs_level_gtl, and dismu_coeff_abs_level_gt2, or maxGtN=4 may be used to code/decode the syntax elements dismu_coeff_abs_level_gt0, dismu_coeff_abs_level_gtl, dismu_coeff_abs_level_gt2, dismu_coeff_abs_level_gt3, and dismu_coeff_abs_level_gt4.

The inverse quantization unit 3053 performs inverse quantization based on a quantization scale value iscale to derive a transformed (for example, wavelet-transformed) mesh displacement Tdisp. Tdisp may be a value in a Cartesian coordinate system or a local coordinate system. iscale is a value derived from the quantization parameter of each component of a mesh displacement image. Inverse quantization may be performed for each submesh unit indicated by subMeshID (displSubMeshID).

$$Tdisp [ subMeshID ] [ 0 ] [ ] = ( Qdisp [ subMeshID ] [ 0 ] [ ] * iscale [ 0 ] + iscaleOffset ) >> iscaleShift$$

$$Tdisp [ subMeshID ] [ 1 ] [ ] = ( Qdisp [ subMeshID ] [ 1 ] [ ] * iscale [ 1 ] + iscaleOffset ) >> iscaleShift$$

$$Tdisp [ subMeshID ] [ 2 ] [ ] = ( Qdisp [ subMeshID ] [ 2 ] [ ] * iscale [ 2 ] + iscaleOffset ) >> iscaleShift$$

Here, iscaleOffset=1 «(iscaleShift-1). iscaleShift may be a predetermined constant, or may be a value coded at a sequence level, a picture/frame level, a submesh level indicated by subMeshID (=displSubMeshID), a tile/patch level, or the like and decoded from coded data.

The inverse transform processing unit 3054 performs an inverse transform g (for example, an inverse wavelet transformed) and derives a mesh displacement d.
d[0][ ]=g(Tdisp[subMeshID][0][j])
d[1][ ]=g(Tdisp[subMeshID][1][ ])
d[2][ ]=g(Tdisp[subMeshID][2][j])

The coordinate system conversion unit 3055 converts the mesh displacement (the coordinate system for mesh displacements) into a Cartesian coordinate system based on the value of coordinate system conversion information displacementCoordinateSystem. Specifically, in a case that displacementCoordinateSystem==1, the displacement in the local coordinate system is converted into the displacement in the Cartesian coordinate system. Here, d is a three-dimensional vector indicating a mesh displacement before coordinate system conversion. disp is a three-dimensional vector indicating a mesh displacement after coordinate system conversion and is a value in the Cartesian coordinate system. n_vec, t_vec, and b_vec are three-dimensional vectors (in the Cartesian coordinate system) corresponding to the axes of a local coordinate system of a target region or target vertex.

```
if (displacementCoordinateSystem == 0) [symbol]
  disp = d [symbol]
else if (displacementCoordinateSystem == 1) [symbol]
  disp = d[0] * n_vec + d[1] * t_vec + d[2] * b_vec

[symbol]

[symbol]

indicates data missing or illegible when filed
```

Derivation methods described above using vector multiplication can be individually expressed as scalars as follows.

```
if (displacementCoordinateSystem == 0) {
    for (i = 0; i < 3; i++) {disp[i] = d[i]}
} else if (displacementCoordinateSystem == 1) {
    for (i = 0; i < 3; i++) {disp[i] =
    d[0] * n_vec[i] + d[1] * t_vec[i] + d[2] *
  b_vec[i]}
}
```

Note that it is also possible to adopt a configuration in which the same variable name is assigned to the values before and after transform such that disp=d and the value of d is updated through coordinate conversion.

Alternatively, the following configuration may be used.

```
if (displacementCoordinateSystem == 0) {
  disp = d
} else if (displacementCoordinateSystem == 1) {
  disp = d[0] * n_vec + d[1] * t_vec + d[2] * b_vec
} else if (displacementCoordinateSystem == 2) {
  disp = d[0] * n_vec2 + d[1] * t_vec2 + d[2] * b_vec2
}
```

Here, n vec2, t vec2, and b vec2 are three-dimensional vectors (in the Cartesian coordinate system) corresponding to the axes of a local coordinate system of an adjacent region.

Alternatively, the following configuration may be used.

```
if (displacementCoordinateSystem == 0) {
  disp = d
} else if (displacementCoordinateSystem == 1) {
  disp = d[0] * n_vec3 + d[1] * t_vec3 + d[2] * b_vec3
}
```

Here, n_vec3, t_vec3, and b_vec3 are three-dimensional vectors (in the Cartesian coordinate system) corresponding to the axes of a local coordinate system of a target region with reduced fluctuations. For example, a vector in the coordinate system used for decoding is derived from the previous coordinate system and the current coordinate system as follows.

$$n\_vec 3 = ( w * n\_vec 3 + ( WT - w ) * n\_vec ) >> wShift$$

$$t\_vec 3 = ( w * t\_vec 3 + ( WT - w ) * t\_vec ) >> wShift$$

$$b\_vec 3 = ( w * b\_vec 3 + ( WT - w ) * b\_vec ) >> wShift$$

Here, for example, wShift=2, 3, 4, WT=1«wShift, and w=1.. WT-1. For example, in a case that w=3 and wShift=3,

$$n\_vec 3 = ( 3 * n\_vec 3 + 5 * n\_vec ) >> 3$$

$$t\_vec 3 = ( 3 * t\_vec 3 + 5 * t\_vec ) >> 3$$

$$b\_vec 3 = ( 3 * b\_vec 3 + 5 * b\_vec ) >> 3$$

The vectors may be selected according to the value of coordinate system conversion information displacementCoordinateSystem decoded from coded data as in the following configuration,

```
if (displacementCoordinateSystem == 0) {
  disp = d
} else if (displacementCoordinateSystem == 1) {
  disp = d[0] * n_vec + d[1] * t_vec + d[2] * b_vec
} else if (displacementCoordinateSystem == 6) {
  disp = d[0] * n_vec3 + d[1] * t_vec3 + d[2] * b_vec3
}
```

### Reconstruction of Mesh

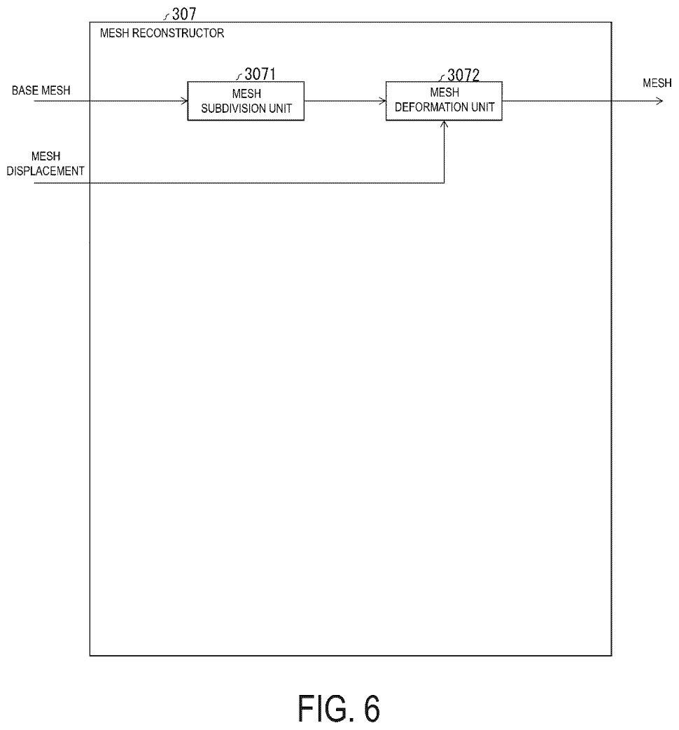

FIG. 6 is a functional block diagram illustrating a configuration of the mesh reconstructor 307. The mesh reconstructor 307 includes a mesh subdivision unit 3071 and a mesh deformation unit 3072.

The mesh subdivision unit 3071 subdivides a base mesh output from base mesh decoder 303 to generate a subdivided mesh.

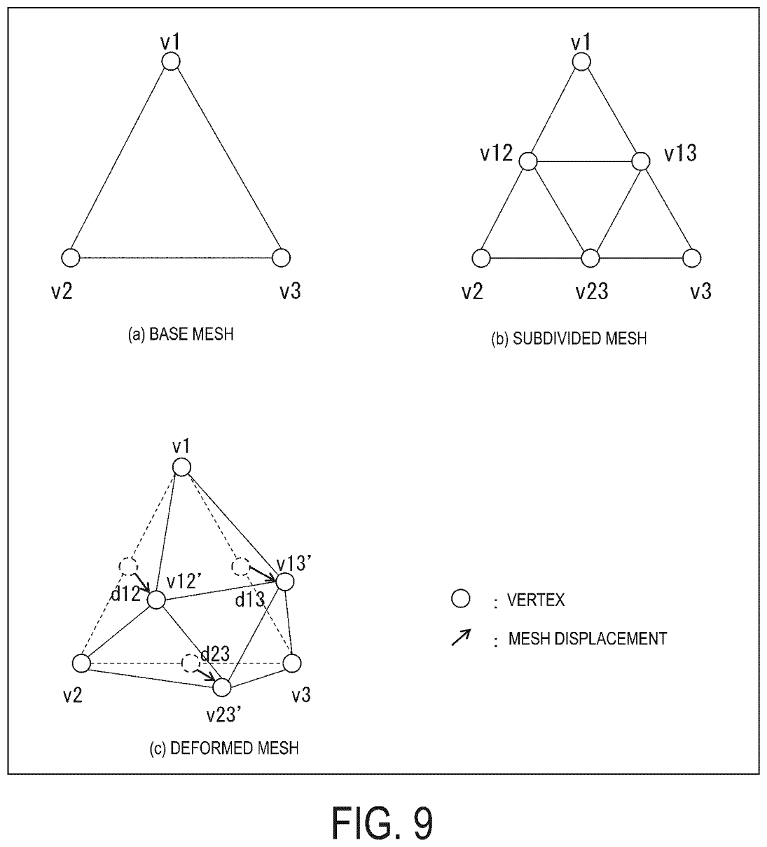

Part (a) of FIG. 9 illustrates a part (triangle) of the base mesh, and the triangle includes vertices v1, v2, and v3. v1, v2, and v3 are three-dimensional vectors. The mesh subdivision unit 3071 generates subdivided meshes by adding new vertices v12, v13, and v23 to the middle of the respective sides of the triangle, and outputs the subdivided meshes (Part (b) of FIG. 9).

$$v 12 = ( v 1 + v 2 ) / 2$$

$$v 13 = ( v 1 + v 3 ) / 2$$

$$v 23 = ( v 2 + v 3 ) / 2$$

The following may also be used.

$$v 12 = ( v 1 + v 2 + 1 ) >> 1$$

$$v 13 = ( v 1 + v 3 + 1 ) >> 1$$

$$v 23 = ( v 2 + v 3 + 1 ) >> 1$$

The mesh deformation unit 3072 receives the subdivided meshes and mesh displacements, generates a deformed mesh by adding the mesh displacements d12, d13, and d23, and outputs the deformed mesh (Part (c) of FIG. 9). The mesh displacements d12, d13, and d23 are the output of the mesh displacement decoder 305 (the coordinate system conversion unit 3055). The mesh displacements d12, d13, and d23 are mesh displacements corresponding to the vertices v12, v13, and v23 added by the mesh subdivision unit 3071.

$$v {12}^{′} = v 12 + d 12$$

$$v {13}^{′} = v 13 + d 13$$

$$v {23}^{′} = v 23 + d 23$$

Note that d12=disp[0][ ], d13=disp[1][ ], and d23=disp[3][ ] may be satisfied.

### Configuration of 3D Data Coding Apparatus According to First Embodiment

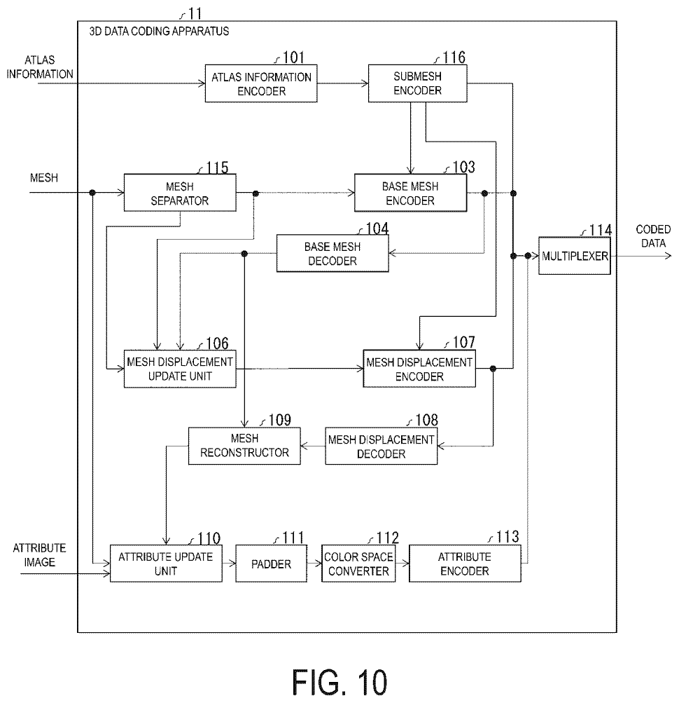

FIG. 10 is a functional block diagram illustrating a schematic configuration of the 3D data coding apparatus 11 according to the first embodiment. The 3D data coding apparatus 11 includes an atlas information encoder 101, a base mesh encoder 103, a base mesh decoder 104, a mesh displacement update unit 106, a mesh displacement encoder 107, a mesh displacement decoder 108, a mesh reconstructor 109, an attribute update unit 110, a padder 111, a color space converter 112, an attribute encoder 113, a submesh encoder 116, a multiplexer 114, and a mesh separator 115. The 3D data coding apparatus 11 receives atlas information, a base mesh, mesh displacements, a mesh, and attribute image as 3D data and outputs coded data.

The atlas information encoder 101 codes the atlas information and outputs a coded atlas information stream.

The base mesh encoder 103 codes the base mesh and outputs a coded base mesh stream. Draco or the like is used as a coding scheme.

The base mesh decoder 104 is similar to the base mesh decoder 303 and thus description thereof will be omitted.

The mesh displacement update unit 106 adjusts the mesh displacements based on the (original) base mesh and the decoded base mesh and outputs the updated mesh displacement.

The mesh displacement encoder 107 codes the updated mesh displacements and outputs a coded mesh displacement stream.

The mesh displacement decoder 108 is similar to the mesh displacement decoder 305 and thus description thereof will be omitted.

The mesh reconstructor 109 is similar to the mesh reconstructor 307 and thus description thereof will be omitted.

The attribute update unit 110 receives the (original) mesh, the reconstructed mesh output from the mesh reconstructor 109 (the mesh deformation unit 3072), and the attribute image and updates the attribute image to match the positions (coordinates) of the reconstructed mesh and outputs the updated attribute image.

The padder 111 receives the attribute image and performs padding processing on an area where pixel values are empty.

The color space converter 112 performs color space conversion from an RGB format to a YCbCr format.

The attribute encoder 113 codes the YCbCr-format attribute image output from the color space converter 112 and outputs an attribute video stream. VVC, HEVC, or the like is used as a coding scheme.

The submesh encoder 116 codes the submesh information of the coded atlas information stream.

The multiplexer 114 multiplexes the coded atlas information submesh stream, the coded base mesh stream, the coded mesh displacement stream, and the attribute video stream and outputs the multiplexed data as coded data. A byte stream format, the ISOBMFF, or the like is used as a multiplexing method.

### Operation of Mesh Separator

The mesh separator 115 generates a base mesh and mesh displacements from a mesh.

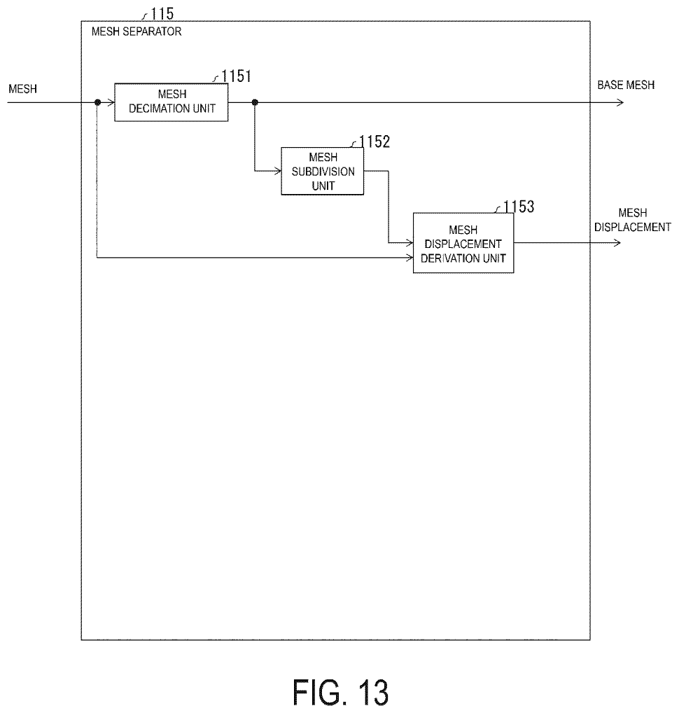

FIG. 13 is a functional block diagram illustrating a configuration of the mesh separator 115. The mesh separator 115 includes a mesh decimation unit 1151, a mesh subdivision unit 1152, and a mesh displacement derivation unit 1153.

The mesh decimation unit 1151 generates a base mesh by removing some vertices from the mesh.

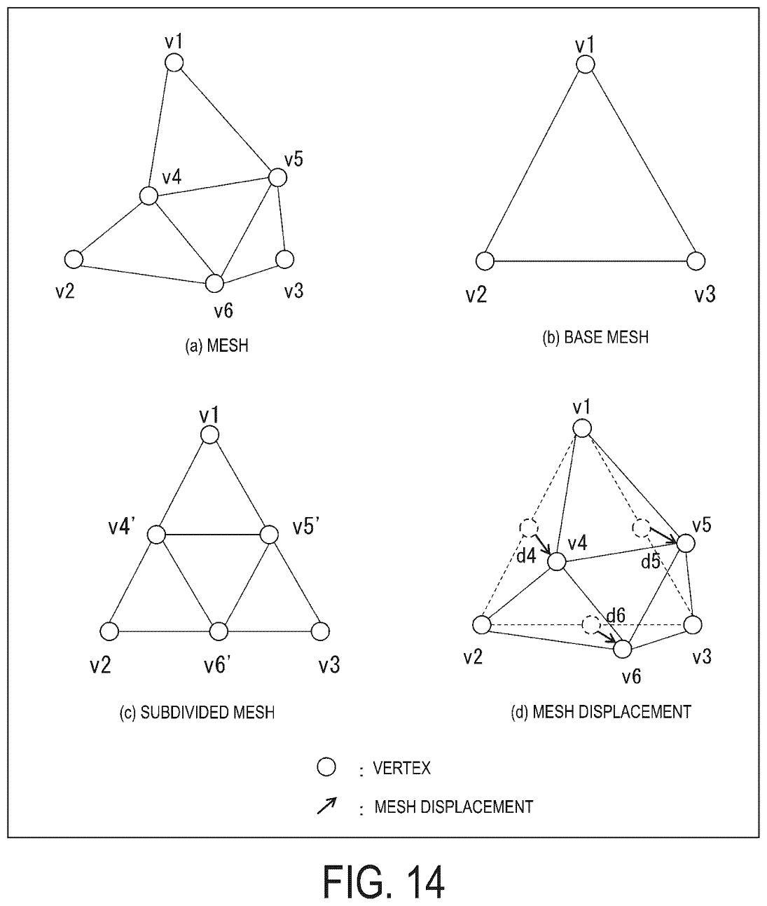

Part (a) of FIG. 14 illustrates a part of a mesh, and the mesh includes vertices v1, v2, v3, v4, v5, and v6. v1, v2, v3, v4, v5, and v6 are three-dimensional vectors. The mesh decimation unit 1151 generates a base mesh by decimating the vertices v4, v5, and v6 (Part (b) of FIG. 14).

Like the mesh subdivision unit 3071, the mesh subdivision unit 1152 subdivides the base mesh to generate a subdivided mesh (Part (c) of FIG. 14).

$$v {4}^{′} = ( v 1 + v 2 ) / 2$$

$$v {5}^{′} = ( v 1 + v 3 ) / 2$$

$$v {6}^{′} = ( v 2 + v 3 ) / 2$$

Based on the mesh and the subdivided mesh, the mesh displacement derivation unit derives, as mesh displacements, displacements d4, d5, and d6 of the vertices v4, v5, and v6 with respect to the vertices v4′, v5′, and v6′ and outputs the displacements d4, d5, and d6 (Part (d) of FIG. 14).

$$d 4 = v 4 - v {4}^{′}$$

$$d 5 = v 5 - v {5}^{′}$$

$$d 6 = v 6 - v {6}^{′}$$

### Coding of Base Mesh

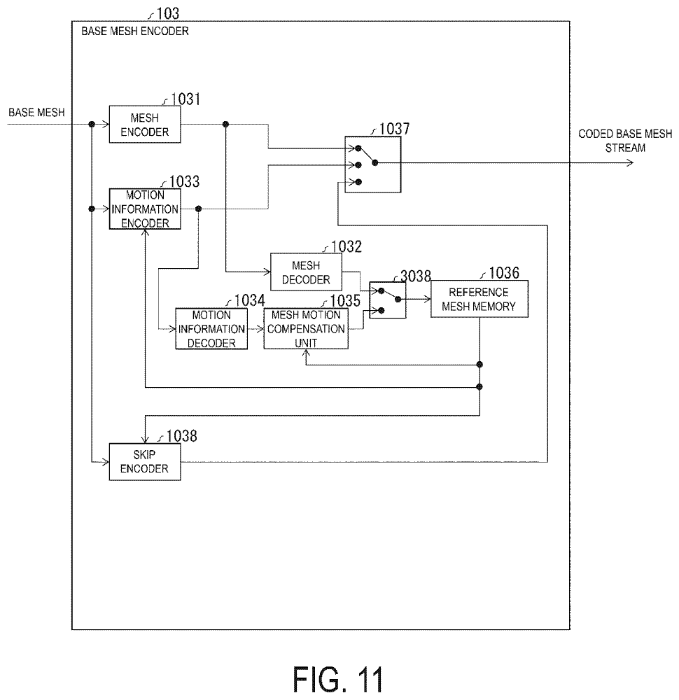

FIG. 11 is a functional block diagram illustrating a configuration of the base mesh encoder 103. The base mesh encoder 103 includes a mesh encoder 1031, a mesh decoder 1032, a motion information encoder 1033, a motion information decoder 1034, a mesh motion compensation unit 1035, a reference mesh memory 1036, a switch 1037, and a switch 1038. The base mesh encoder 103 may include a base mesh quantization unit (not illustrated) after the input of a base mesh. Each of the switches 1037 and 1038 is connected to the side where no motion compensation is performed in a case that the base mesh is to be coded (intra-coded) without reference to other base meshes (for example, base meshes that have already been coded). On the other hand, each of the switches 1037 and 1038 is connected to the side where motion compensation is performed in a case that the base mesh is to be coded (inter-coded) with reference to another base mesh.

The mesh encoder 1031 has an intra coding function and intra-codes the base mesh, and outputs a coded base mesh stream. Draco or the like is used as a coding scheme.

The mesh decoder 1032 is similar to the mesh decoder 3031 and thus description thereof will be omitted.

The motion information encoder 1033 has an inter-coding function and inter-codes the base mesh and outputs a coded base mesh stream. Entropy coding such as arithmetic coding is used as a coding scheme.

The motion information decoder 1034 is similar to the motion information decoder 3032 and thus description thereof will be omitted.

The mesh motion compensation unit 1035 is similar to the mesh motion compensation unit 3033 and thus description thereof will be omitted.

The reference mesh memory 1036 is similar to the reference mesh memory 3034 and thus description thereof will be omitted.

### Coding of Mesh Displacements

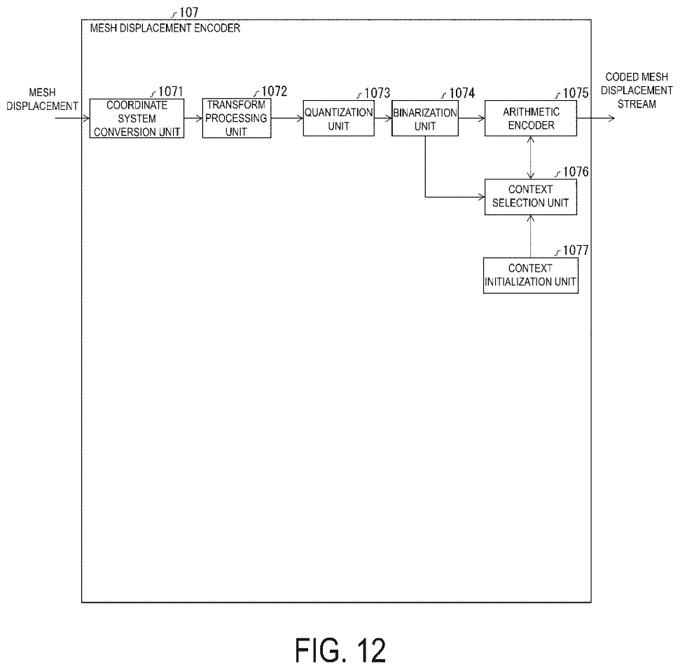

FIG. 12 is a functional block diagram illustrating a configuration of the mesh displacement encoder 107. The mesh displacement encoder 107 includes a coordinate system conversion unit 1071, a transform processing unit 1072, a quantization unit 1073, a binarization unit 1074, an arithmetic encoder 1075, a context selection unit 1076, and a context initialization unit 1077.

Based on the value of the coordinate system conversion information displacementCoordinateSystem, the coordinate system conversion unit 1071 converts the coordinate system of the mesh displacement from the Cartesian coordinate system to a coordinate system (for example, a local coordinate system) in which the displacement is coded.

Here, disp is a three-dimensional vector indicating a mesh displacement before coordinate system conversion, d is a three-dimensional vector indicating a mesh displacement after coordinate system conversion, and n_vec, t_vec, and b_vec are three-dimensional vectors (in the Cartesian coordinate system) corresponding to the axes of the local coordinate system.

```
if (displacementCoordinateSystem == 0) {
  d = disp
} else if (displacementCoordinateSystem == 1) [symbol]
  d = (disp * n_vec, disp * t_vec, disp * b_vec)
} [symbol]
indicates data missing or illegible when filed
```

The mesh displacement encoder 107 may update the value of displacementCoordinateSystem at the sequence level. Alternatively, the value may be updated at the picture/frame level. The initial value is 0, indicating the Cartesian coordinate system.

In a case that displacementCoordinateSystem is updated at the sequence level, the syntax of the configuration of FIG. 7 is used. asps_vdmc_ext_displacement_coordinate_system is set equal to 0 in a case of the Cartesian coordinate system and is set equal to 1 in a case of the local coordinate system.

In a case that displacementCoordinateSystem is changed at a picture/frame level, the syntax of the configuration of FIG. 8 is used. afps_vdmc_ext displacement_coordinate_system_enable_flag is set equal to 1 in a case that the coordinate system is updated and is set equal to 0 in a case that the coordinate system is not updated. afps_vdmc_ext_displacement_coordinate_system is set to 0 in a case of the Cartesian coordinate system and is set equal to 1 in a case of the local coordinate system.

The transform processing unit 1072 performs transform f (for example, wavelet transformed) and derives a transformed mesh displacement Tdisp.
Tdisp[displSubMeshID][0][ ]=f(d[displSubMeshID][0] ])
Tdisp[displSubMeshID][1][ ]=f(d[displSubMeshID][1][ ])
Tdisp[displSUbMeshID][2][ ]=f(d[displSubMeshID][2][ ])

The quantization unit 1073 performs quantization based on a quantization scale value “scale” derived from the quantization parameter of each component of mesh displacements to derive a quantized mesh displacement Qdisp.

$$Qdisp [ displSubMeshID ] [ 0 ] [ ] = Tdisp [ displSubMeshID ] [ 0 ] [ ] / scale [ 0 ]$$

$$Qdisp [ displSubMeshID ] [ 1 ] [ ] = Tdisp [ displSubMeshID ] [ 1 ] [ ] / scale [ 1 ]$$

$$Qdisp [ displSubMeshID ] [ 2 ] [ ] = Tdisp [ displSubMeshID ] [ 2 ] [ ] / scale [ 2 ]$$

Alternatively, the scale value may be approximated by a power of 2 and Qdisp may be derived using the following formula.

$$scale [ i ] = 1 << scale 2 [ i ]$$

$$Qdisp [ displSubMeshID ] [ 0 ] [ ] = Tdisp [ displSubMeshID ] [ 0 ] [ ] >> scale 2 [ 0 ]$$

$$Qdisp [ displSubMeshID ] [ 1 ] [ ] = Tdisp [ displSubMeshID ] [ 1 ] [ ] >> scale 2 [ 1 ]$$

$$Qdisp [ displSubMeshID ] [ 2 ] [ ] = Tdisp [ displSubMeshID ] [ 2 ] [ ] >> scale 2 [ 2 ]$$

The binarization unit 1074 codes the quantized mesh displacement Qdisp, which is a multi-valued signal, into a binary signal. The binary signal may be a k-th order exponential Golomb code.

The arithmetic encoder 1075 performs arithmetic coding on the binary signal and outputs a coded mesh displacement stream.

The context selection unit 1076 is similar to the context selection unit 3056, and thus description of the context selection unit 1076 will be omitted.

Note that a static context with a fixed probability without context update is referred to as a ctxStatic. The syntax element indicated by ctxStatic may be coded without using a context. encode(ctxStatic) may use dedicated processing for bypass as encode bypasso.

The context initialization unit 1077 is similar to the context initialization unit 3057, and thus description of the context initialization unit 1077 will be omitted.

An example in which contexts are used will be described here. However, some syntax elements may be bypass-coded without using a context. A configuration performing bypass coding is effective in reducing the memory for contexts and the amount of processing.

For example, the syntax element dismu_coeff_abs_level_rem may be bypass-coded without using a context. Bypass-coding these syntax elements is effective in reducing the memory for contexts and the amount of processing, while maintaining the coding efficiency.

The mesh displacement encoder 107 codes the mesh displacement Qdisp by the following processing.

```
for (k = 0; k < numDim [symbol]  k++) { // dimension (component) loop
  if ( [symbol] lastSig) continue
  dispOffset = 0
  for (b = 0; b [symbol] numLOD; b++) { // Level of Detail loop [symbol]  block loop
    numBlocks = dispCount [symbol]  / subBlockSize + 1
    for (s = 0; s < numBlocks; s++) { // subblock loop
      // encode dismu_nz_subBlock
      encode(dismu_nz_subBlock[k][b][s], [symbol]
      txCodedSubBlock[st][b][k])
      for [symbol]  // coefficient loop within subblock
        // encode dismu_coeff_abs_level_gt0
        d = Qdisp[dispOffset + s * subBlockSize + v][k]
        encode (d [symbol] = 0 [symbol] )
        if ( [symbol] d) continue
        // encode dismu_coeff_sign
        encode (d [symbol]  0, [symbol] )
        d = [symbol]  1
        // encode dismu_coeff_abs_level_gt1
        encode(d [symbol] = 0, [symbol] txCoeffGtN [symbol] )
        if ( [symbol] d) continue
        d = [symbol]  1
        // encode dismu_coeff_abs_level_gt2
        encode(d != 0, [symbol] txCoeffGtN [symbol] )
        if ( [symbol] d) continue
        d = abs(d) [symbol]  1
        // encode dismu_coeff_abs_level_gt3
        encode(d [symbol] = 0 [symbol] )
        if ( [symbol] d) continue
        // encode dismu_coeff_abs_level

[symbol]

[symbol]

      }
    }
    dispOffset += dispCount[b]
  }
} [symbol]
indicates data missing or illegible when filed
```

continue in pseudocode means skipping the following operation and jumping to the beginning of the loop (next iteration).

Here, encodeo and encodeExpGolombo are functions for arithmetically coding a 1-bit value and a binary string of the k-th order Golomb code with values and corresponding contexts being arguments, respectively. dispCount[b] is the number of mesh displacements of the level of detail b. lastSig is a flag indicating whether the current coefficient is the last non-zero coefficient in the subblock in scan order. lastSig=0 indicates that the current coefficient is not the last non-zero coefficient in the subblock in scan order. lastSig=1 indicates that the current coefficient is the last non-zero coefficient in the subblock in scan order.

Alternatively, the mesh displacement Qdisp may be coded by the following processing.

```
for (k = 0; k [symbol]  numDim; k++) [symbol]  // dimension (component) loop
  if ( [symbol] astSig) continue
  dispOffset = 0
  for (b = 0 [symbol]  b [symbol] numLOD [symbol]  b++) [symbol]  // Level of Detail loop, block loop
    numBlocks = dispCount[b] / subBlockSize + 1
    for (s = 0 [symbol]  s [symbol]  numBlocks [symbol]  s++) [symbol]  // subblock loop
      // encode dismu_nz_subBlock
      encode(dismu_nz_subBlock[k][b][s], [symbol]
      txCodedSubBlock[st][b][k])
      for ( [symbol]  = 0; [symbol]  subBlockSize [symbol] [symbol]   ++) [symbol]
      // coefficient loop within subblock
        // encode dismu_coeff_abs_level_gt0
        d = Qdisp[dispOffset + s * subBlockSize + v][k]
        encode (d [symbol] = 0, [symbol] txCoeffGtN[st][b][0][k])
        if ( [symbol] d) continue
        // encode dismu_coeff_sign
        encode(d [symbol]  0, [symbol] txStatic)
        N = 1
        maxGtN = 3
        while (N <= maxGtN) [symbol]
          d = abs(d) [symbol]
          // encode dismu_coeff_abs_level_gtN [symbol]
          encode(d != 0, [symbol] txCoeffGtN[st][b][N][k])
          if ( [symbol] d) break
          N++
        }
        if (d) {
          // encode dismu_coeff_abs_level_rem
          encodeExpGolomb [symbol]
        }
      }
    }
    dispOffset += dispCount[b]
  }
} [symbol]
indicates data missing or illegible when filed
```

Note that maxGtN is not limited to 3, and for example, maxGtN=2 may be used to code the syntax elements dismu_coeff_abs_level_gt0, dismu_coeff_abs_level_gtl, and dismu_coeff_abs_level_gt2, or maxGtN=4 may be used to code the syntax elements dismu_coeff_abs_level_gt0, dismu_coeff_abs_level_gtl, dismu_coeff_abs_level_gt2, dismu_coeff_abs_level_gt3, and dismu_coeff_abs_level_gt4.

Although embodiments of the present disclosure have been described above in detail with reference to the drawings, the specific configurations thereof are not limited to those described above and various design changes or the like can be made without departing from the spirit of the disclosure.

### Application Example

The 3D data coding apparatus 11 and the 3D data decoding apparatus 31 described above can be used by being installed in various apparatuses that transmit, receive, record, and reproduce 3D data. Note that the 3D data may be natural 3D data captured by a camera or the like or may be artificial 3D data (including CG and GUI) generated by a computer or the like.

An embodiment of the present disclosure is not limited to the embodiments described above and various changes can be made within the scope indicated by the claims. That is, embodiments obtained by combining technical means appropriately modified within the scope indicated by the claims are also included in the technical scope of the present disclosure.

### INDUSTRIAL APPLICABILITY

Embodiments of the present disclosure are suitably applicable to a 3D data decoding apparatus that decodes coded data into which 3D data has been coded and a 3D data coding apparatus that generates coded data into which 3D data has been coded. Embodiments of the present disclosure are also suitably applicable to a data structure for coded data generated by a 3D data coding apparatus and referenced by a 3D data decoding apparatus.

### REFERENCE SIGNS LIST

11 3D data coding apparatus
101 Atlas information encoder
103 Base mesh encoder
1031 Mesh encoder
1032 Mesh decoder
1033 Motion information encoder
1034 Motion information decoder
1035 Mesh motion compensation unit
1036 Reference mesh memory
1037 Switch
1038 Switch
1039 Skip coding
104 Base mesh decoder
106 Mesh displacement update unit
107 Mesh displacement encoder
1071 Coordinate system conversion unit
1072 Transform processing unit
1073 Quantization unit
1074 Binarization unit
1075 Arithmetic encoder
1076 Context selection unit
1077 Context initialization unit
108 Mesh displacement decoder
109 Mesh reconstructor
110 Attribute update unit
111 Padder
112 Color space converter
113 Attribute encoder
114 Multiplexer
115 Mesh separator
1151 Mesh decimation unit
1152 Mesh subdivision unit
1153 Mesh displacement derivation unit
116 Submesh encoder
21 Network
31 3D data decoding apparatus
301 Demultiplexer
302 Atlas information decoder
303 Base mesh decoder
3031 Mesh decoder
3032 Motion information decoder
3033 Mesh motion compensation unit
3034 Reference mesh memory
3035 Switch
3036 Switch
3037 Skip decoder
305 Mesh displacement decoder
3051 Arithmetic decoder
3052 De-binarization unit
3053 Inverse quantization unit
3054 Inverse transform processing unit
3055 Coordinate system conversion unit
3056 Context selection unit
3057 Context initialization unit
307 Mesh reconstructor
306 Attribute decoder
3071 Mesh subdivision unit
3072 Mesh deformation unit
308 Color space converter
309 Submesh decoder
41 3D data display apparatus

1. A 3D data decoding apparatus for decoding mesh data or point cloud data, the 3D data decoding apparatus comprising:
a submesh decoder configured to decode submesh information from encoded data in which the mesh data or the point cloud data is encoded;
a base mesh decoder configured to decode a base mesh from the encoded data and the submesh information;
a mesh displacement decoder configured to decode a mesh displacement from the encoded data and the submesh information; and
a mesh reconstructor configured to decode a mesh from the base mesh and the mesh displacement being decoded, wherein
the mesh displacement decoder decodes the mesh displacement from the encoded data, by using the submesh information decoded in the submesh decoder.

2. The 3D data decoding apparatus according to claim 1, wherein
the submesh decoder includes a flag indicating whether or not a submesh of the base mesh and the submesh of the mesh displacement correspond to each other.

3. The 3D data decoding apparatus according to claim 1, wherein
the submesh decoder decodes a syntax element for the number of submeshes minus 2, depending on a flag indicating whether or not there are more than one submeshes.

4. The 3D data decoding apparatus according to claim 1, wherein
the mesh displacement decoder decodes the submesh information of the mesh displacement in the mesh displacement decoder in a case of not decoding the submesh information of the mesh displacement in the submesh decoder.

5. A 3D data coding apparatus for coding mesh data or point cloud data, the 3D data coding apparatus comprising:
a submesh encoder configured to encode submesh information;
a base mesh encoder configured to encode a base mesh, by using the submesh information; and
a mesh displacement encoder configured to encode a mesh displacement, by using the submesh information, wherein
the mesh displacement encoder encodes the mesh displacement, by using the submesh information encoded in the submesh encoder.

6. The 3D data coding apparatus according to claim 5, wherein
the submesh encoder includes a flag indicating whether or not a submesh of the base mesh and the submesh of the mesh displacement correspond to each other.

7. The 3D data coding apparatus according to claim 5, wherein
the submesh encoder encodes a syntax element for the number of submeshes minus 2, depending on a flag indicating whether or not there are more than one submeshes.

8. The 3D data coding apparatus according to claim 5, wherein
the mesh displacement encoder encodes the submesh information of the mesh displacement in the mesh displacement encoder in a case of not encoding the submesh information of the mesh displacement in the submesh encoder.
